(19) United States
(12) Patent Application Publication
(10) Pub. No.: US 2026/0330205 A1
(43) Pub. Date: Oct. 22, 2026

(54) LOW-LATENCY COMPUTE ARCHITECTURES AND USE FOR NEURAL NETWORK INFERENCE

(71) Applicant: NVIDIA Corporation, Santa Clara, CA (US)

(72) Inventors: William James Dally, Incline Village, NV (US); Po-An Tsai, Somerville, MA (US); Brian Matthew Zimmer, Sunnyvale, CA (US); Rangharajan Venkatesan, San Jose, CA (US)

(21) Appl. No.: 19/371,545

(22) Filed: Oct. 28, 2025

Related U.S. Application Data
(60) Provisional application No. 63/792,579, filed on Apr. 22, 2025.
(60) Provisional application No. 63/880,427, filed on Sep. 12, 2025.

(51) Int. Cl. G06N 3/063; G06F 15/16; G06F 15/173

(52) U.S. Cl. CPC G06N 3/063; G06F 15/161; G06F 15/17337

(57) ABSTRACT

A low-latency processing system reduces data movement, improves memory bandwidth utilization, and enables, e.g., scalable, low-latency neural network inference. Compute tiles are configured to efficiently execute activation functions in parallel. Each compute tile includes an array of basic units equipped with local SRAM, vector registers, and multiply-accumulate (MAC) units, enabling localized computation to minimize data movement and reduce latency. IMLP tiles efficiently perform data format conversions and reduction operations as part of intermediate layer processing. A configurable network transmits data directly from source to destination register(s) within compute and IMLP tiles. Connections are, e.g., pre-configured for one or more cycles of neural network inference.

### CLAIM OF PRIORITY

This application claims the benefit of U.S. Provisional Application Nos. 63/792,579, titled “Low-Latency LLM Decode System” filed Apr. 22, 2025 and 63/880,427, titled “Low-Latency Compute Architectures and Use for Neural Network Inference” and filed Sep. 12, 2025, the entire contents of which are incorporated herein by reference.

### BACKGROUND

Neural networks, e.g., large language models (LLMs) and other transformer-based architectures, have become central to many modern computational tasks, with applications spanning virtual assistants, conversational agents, real-time language translation, automated content generation, autonomous driving, robotics, and more. Their deployment in real-time applications, however, continues to face challenges. While conventional computing systems are capable of performing extensive matrix-vector computations and reduction operations in bulk, such systems remain suboptimal for meeting the low-latency and high-efficiency demands of real-time applications. The need to coordinate fine-grained data movement among processing elements and manage high memory throughput exacerbates latency issues, potentially reducing the responsiveness of inference systems. There is a need for improved hardware architectures that can more effectively distribute computational tasks and streamline data transfers, thereby meeting the rising performance expectations for next-generation neural network deployments.

### BRIEF DESCRIPTION OF THE DRAWINGS

The present low-latency compute architectures and their use for neural network inference are described in detail below with reference to the attached drawing figures, wherein:

FIG. 1A illustrates a block diagram of an example LLM system, according to at least one embodiment.

FIG. 1B illustrates a block diagram of example LLM processing operations, according to at least one embodiment.

FIG. 2A illustrates a block diagram of an example basic unit, according to at least one embodiment.

FIG. 2B illustrates a block diagram of an example compute tile, according to at least one embodiment.

FIG. 2C illustrates a block diagram of another example compute tile, according to at least one embodiment.

FIG. 2D illustrates a block diagram of an example IMLP tile, according to at least one embodiment.

FIG. 2E illustrates a block diagram of an example LLI reduction group, according to at least one embodiment.

FIG. 3A illustrates a block diagram of a column of LLI reduction groups and a configurable network connecting different tiles within the reduction groups, according to at least one embodiment.

FIG. 3B illustrates a block diagram of a gather network of an LLI reduction group, according to at least one embodiment.

FIG. 3C illustrates a block diagram of a reduction network of an LLI system, according to at least one embodiment.

FIG. 3D illustrates a block diagram of a distribution network of an LLI system, according to at least one embodiment.

FIG. 3E illustrates a block diagram of a portion of a distribution network at a compute tile, according to at least one embodiment.

FIG. 4A illustrates an LLI device, according to at least one embodiment.

FIG. 4B illustrates a block diagram of example LLM mapping to an LLI system, according to at least one embodiment.

FIG. 4C illustrates a flowchart of a method for performing tensor operations for LLI operations using a set of compute groups, according to at least one embodiment.

FIG. 4D illustrates a flowchart of a method for performing calculations for LLI operations using an IMLP tile, according to at least one embodiment.

FIG. 4E illustrates a flowchart of a method for performing LLI operations, according to at least one embodiment.

FIG. 4F illustrates a timeline for performing LLM operations using an LLI system, according to at least one embodiment.

FIG. 5A illustrates a processing system implemented using the LLI device of FIG. 4A, according to at least one embodiment.

FIG. 5B illustrates a processing system incorporating multiple instances of the processing system of FIG. 5A, according to at least one embodiment.

FIG. 5C illustrates components of an exemplary system that can be used to train a machine learning model, according to at least one embodiment.

FIG. 6 illustrates an exemplary streaming system, according to at least one embodiment.

### DETAILED DESCRIPTION

Low-latency compute architectures and their use for neural network inference are disclosed herein. According to one or more embodiments, low-latency architectures reduce data movement, improve memory bandwidth utilization, and enable scalable, low-latency neural network inference operations, e.g., large language model (LLM) decoding, to overcome limitations of conventional GPU-based systems. In at least one embodiment, data is transmitted directly from a source to destination register(s) through a configurable network, which provides lower latency than conventional on-chip networks, e.g., a mesh or crossbar. In at least one embodiment, the configurable network is configured in accordance with a neural network, e.g., a LLM, and/or processing stage thereof. Low-latency architectures according to one or more embodiments enable next-generation neural networks (e.g., LLMs, other transformer-based architectures, etc.) to meet performance demands of real-time applications while remaining both scalable and energy efficient.

Neural networks have become foundational to numerous applications, including virtual assistants, conversational agents, real-time language translation, automated content generation, autonomous driving, and robotics. However, the extensive tensor operations—which include, without limitation, general matrix-matrix computations (e.g., GEMM operations) and general matrix-vector computations (e.g., GEMV operations, which are a subset of GEMM operations)—required at inference present significant challenges to deployment in real-time applications. While conventional systems (e.g., GPU-based systems) are capable of performing these operations in parallel, they are constrained by their reliance on centralized memory architectures and high data movement overhead. These constraints result in increased latency, particularly as the number of processing layers in the neural network grows (e.g., LLMs, such as Llama 70B, may include 80 layers or more). Additionally, the memory bandwidth required to repeatedly access weights and intermediate states exacerbates these constraints, making it difficult to meet low-latency demands of real-time applications.

According to one or more embodiments, low-latency architectures address the aforementioned challenges to accelerate neural network inference operations (e.g., LLM decoding).

According to one or more embodiments, low-latency architectures integrate compute tiles and inter-matrix layer processing (IMLP) tiles. According to one or more embodiments, low-latency architectures spatially distribute tensor operations (e.g., matrix-matrix and matrix-vector computations) across compute tiles and aggregate partial results at IMLP tiles.

According to one or more embodiments, low-latency architectures integrate a configurable network that directly transmits results between compute and/or IMLP tiles, bypassing the need for centralized storage and significantly reducing communication latency. According to one or more embodiments, low-latency architectures integrate, in addition to the configurable network, a dynamic distribution network for data-dependent communication.

According to one or more embodiments, low-latency architectures are scaled up across multiple chips, boards, and racks, thereby facilitating the deployments of large-scale neural networks (e.g., LLMs, other transformer-based models, etc.) in data centers and edge environments. According to one or more embodiments, low-latency architectures adapt to various neural network configurations, supporting different communication patterns, tensor shapes, context lengths, and reduction dimensions.

In the context of the following description, tensor shape generally refers to the layout or structure of a tensor (e.g., multi-dimensional arrays), defining the number of dimensions (or axes) and the size (number of elements) along each dimension. When a tensor operation involving multiple tensors is performed, each dimension is either a reduction dimension or a non-reduction dimension. According to one or more embodiments, compute tiles, IMLP tiles, and/or tile groups are configured for performing a tensor operation based on a reduction dimension of the tensor operation.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

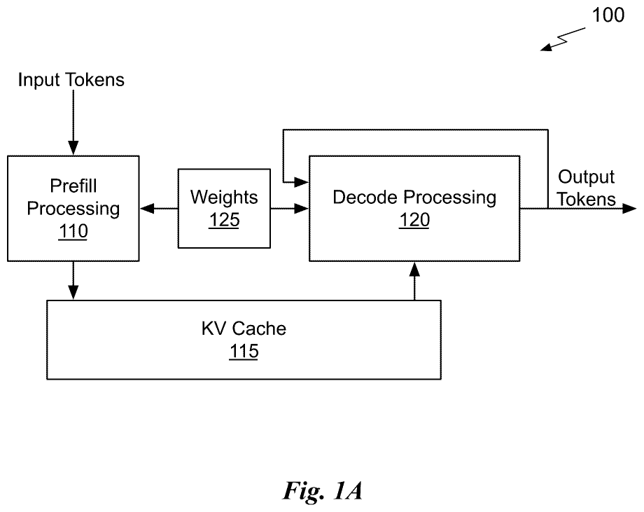

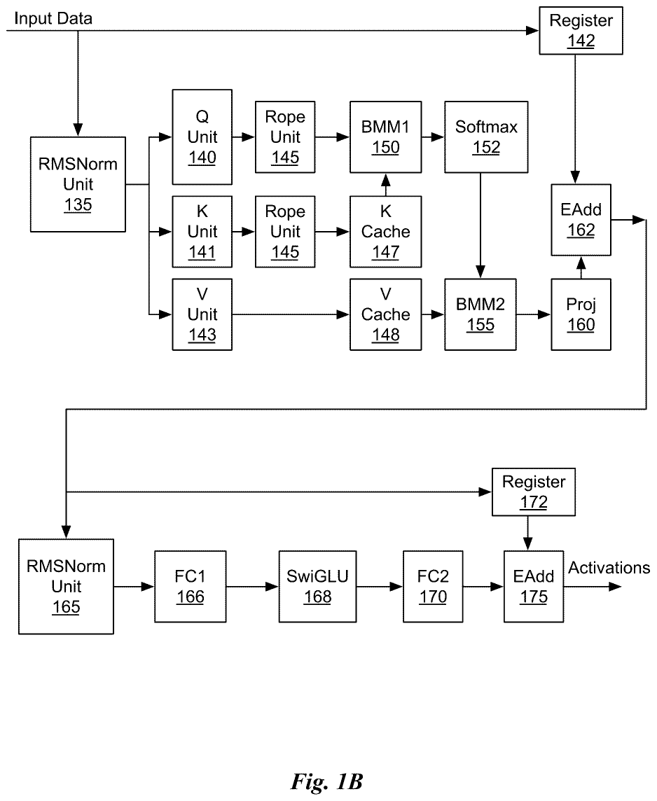

FIG. 1A illustrates a block diagram of an example LLM system 100, according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of LLM system 100 is within the scope and spirit of embodiments of the present disclosure.

The operations required by LLM (e.g., ChatGPT) inferencing are a sequence of many processing layers that process a sequence of input tokens representing a small number of characters in a language (e.g., English). In an embodiment, the LLM system 100 is structured to address two primary phases of LLM inferencing: the prefill phase and the decode phase, with each phase performing a distinct function in the overall processing workflow. Accordingly, prefill processing 110 is configured to handle the initial input tokens (i.e., the prompt). During the prefill phase, the input tokens are processed by the prefill processing 110 to compute intermediate states, including K (key) and V (value) vectors, which play a significant role in generating the first output token. The prefill processing 110 accesses model parameters required for the computations, such as weights 125 that are stored in local on-chip memories. The KV vectors are subsequently stored in KV cache 115, which is maintained on a per-user basis. In an embodiment, KV cache 115 is stored in local on-chip memories. Thus, the intermediate states are readily available for subsequent decode operations, reducing the need for redundant computations and enabling the reuse of the KV vectors during the decode phase.

Decode processing 120 serves as a foundational component of the decode phase. Decode processing 120 involves performing GEMM operations for processing input tokens and generating output tokens. Furthermore, the decode phase is characterized by computational intensity, as it involves multiple processing layers (e.g., 80 layers in models such as Llama 70B). In this context, decode processing 120 retrieves the cached KV vectors from the KV cache 115 and also accesses model parameters required for the computations, such as weights 125 that are stored in local on-chip memories. In an embodiment, weights 125 are accessed repeatedly for each output token, thereby making memory bandwidth a significant factor in the system's performance.

In an embodiment, LLM system 100 addresses the limitations of conventional GPU-based architectures by optimizing data flow and reducing memory bandwidth bottlenecks. By caching the K and V vectors, storing weights 125 in local on-chip memories, and using an efficient architecture for decode processing 120, LLM system 100 minimizes latency and enhances the responsiveness of the decode operations. Moreover, in an embodiment, the output tokens generated by decode processing 120 are fed back into decode processing 120 for autoregressive generation, enabling the model to produce subsequent tokens based on prior outputs. The output tokens are also converted into characters.

In an embodiment, primary components of the LLM system include GPU boards and low latency inference (LLI) boards. In an embodiment, the GPU boards perform prefill operations and the LLI boards perform decode operations. Multiple boards may be connected (via a network) to scale up processing capacity. Adjacent cabinets enclosing the boards may be cabled together for massive capacity. In an embodiment, each LLI board includes a 4×6 array of LLI chips. Each LLI chip includes two different types of tiles, specifically, compute tiles and IMLP (inter-MMA (matrix-multiplier array) layer processing) tiles, as well as shared control, a configurable network, and a dynamic distribution network.

LLM system 100 may be configured to implement a variety of neural networks (e.g., LLMs, other transformer-based models, etc.). In an embodiment, an LLM is mapped to multiple GPU and/or LLI chips with each chip performing the operations for at least a portion of a processing layer of the LLM. The processing includes reduction operations that combine many inputs to produce a small (single value or vector) output. The reduction operations include dot products, max, sum, mean, and the like. The reduction operations are spatially (and sometimes temporally) distributed (mapped) across multiple compute tiles and/or IMLP tiles and the outputs are transmitted directly to one or more tiles for a subsequent calculation. The configurable network is configured to provide direct communication between the different tiles. In an embodiment, a single chip tile may be configured to implement one or more layers of the LLM. At points in the processing where multiple results to be reduced converge, the results are combined (reduced), decreasing the communication bandwidth that is consumed when transmitting data for input to a subsequent calculation.

During decode processing 120, each LLM processing layer typically performs GEMM operations. In an embodiment, compute tiles of one or more LLI chips perform the GEMM operations and partial results computed by each compute tile are combined in an IMLP tile to produce activations at the earliest opportunity (i.e., close to where they are computed or where they converge in the configurable network). The activations are then transferred by the configurable network to one IMLP tile that performs vector/reduction operations to produce a layer result. The configurable network then distributes the layer results to one or more (compute and/or IMLP) tiles for processing by a subsequent decode processing layer.

The configurable network is a latency-optimized interconnect designed for deterministic, low-latency communication between compute tiles and IMLP tiles. This network can be configured based on the specific requirements of the LLM being implemented, enabling direct transmission of intermediate results from one processing stage to the next without reliance on centralized memory, such as SRAM or DRAM. More specifically, intermediate or partial results are transferred directly from a processing unit or register in one tile to a register in another tile without being stored in a shared memory resource (e.g., a register file, cache, SRAM, or DRAM). The configurable network performs two primary functions: (1) gathering and reducing partial results from compute tiles to IMLP tiles for operations such as sum, max, or mean reductions, and (2) distributing the reduced results to subsequent compute or IMLP tiles for further processing. By minimizing data movement and avoiding unnecessary storage operations, the configurable network significantly reduces communication latency and improves energy efficiency. Additionally, the deterministic routing of the network ensures predictable performance, making the system well-suited for real-time neural network inference workloads that demand high throughput and low latency.

FIG. 1B illustrates a block diagram of example LLM processing operations, according to at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the LLM processing operations is within the scope and spirit of embodiments of the present disclosure.

The sequence of computational steps and the interaction between various components in an LLM decode system are depicted in FIG. 1B, where a portion of the components are mapped to and performed by compute tiles and another portion is performed by IMLP tiles to implement the LLM. The input data is transmitted to and stored in a register 142 within one or more compute tiles. In one embodiment, the LLM processing initiates with the input data being processed by an RMSNorm unit 135 that computes a root-mean square that is normalized, ensuring that the input data is scaled appropriately for subsequent operations. Accordingly, the normalized data is used, by each of the computation units, Q unit 140, K unit 141, and V unit 143, to compute the Q (query), K (key), and V (value) vectors, respectively, which are integral to the attention mechanism in LLMs.

For example, the Q and K vectors are processed through respective rope units 145, which apply positional encodings to incorporate sequence information into the vectors. As a result, the processed Q vector is employed in a batch matrix multiplication operation (BMM1 150) with the K vector retrieved from the K cache 147, thereby computing the attention scores. In turn, the attention scores are subsequently forwarded to the softmax unit 152, where the scores are normalized to produce the attention weights.

The attention weights are employed in a second batch matrix multiplication operation (BMM2 155) with the V vector retrieved from the V cache 148, for generating the weighted sum of the values that represents the attended output. Thereafter, the attended output is passed to a projection unit (Proj 160) for dimensionality reduction or transformation. The output of the Proj 160 is then combined with the input data stored in the register 142, via an element-wise addition operation performed by EAdd 162. Additionally, the combined result output by EAdd 162 is stored in a register 172 for further processing.

The combined result output by EAdd 162 is also processed through another RMSNorm unit 165 to perform normalization. Following the normalization, the data undergoes a series of transformations through a fully connected layer (FC1 166), a SwiGLU activation unit 168, and another fully connected layer (FC2 170). These operations, as further detailed herein, are designed to enhance the representational capacity of the model by applying non-linear transformations and dense connections.

For example, the output of FC2 170 is combined with the combined result output by the register 172 via another element-wise addition operation (EAdd 175), and the final result represents activations generated by the LLM processing layer. These activations, accordingly, may then serve as input for subsequent layers or as the final output of the LLM.

In one or more embodiments, an LLM is mapped to multiple GPU and LLI chips with each chip performing the operations for at least a portion of a processing layer of the LLM. The processing includes reduction operations that combine many inputs to produce a small (single value or vector) output. The reduction operations include dot products, max, sum, mean, etc. The reduction operations are spatially (and sometimes temporally) distributed (mapped) across multiple compute/IMLP tiles of one or more LLI chips and the outputs are transmitted directly to one or more compute tiles for a subsequent calculation. In an embodiment, an entire LLM is mapped to multiple chips and at least a portion of the LLM is mapped to the tiles on each LLI chip. In an embodiment, a single chip tile may be configured to implement one or more layers of the LLM. At points where multiple results to be reduced converge, the results are combined (reduced), reducing the communication bandwidth that is consumed for the calculation.

### Compute Tile, IMLP Tile, and LLI Gather Group

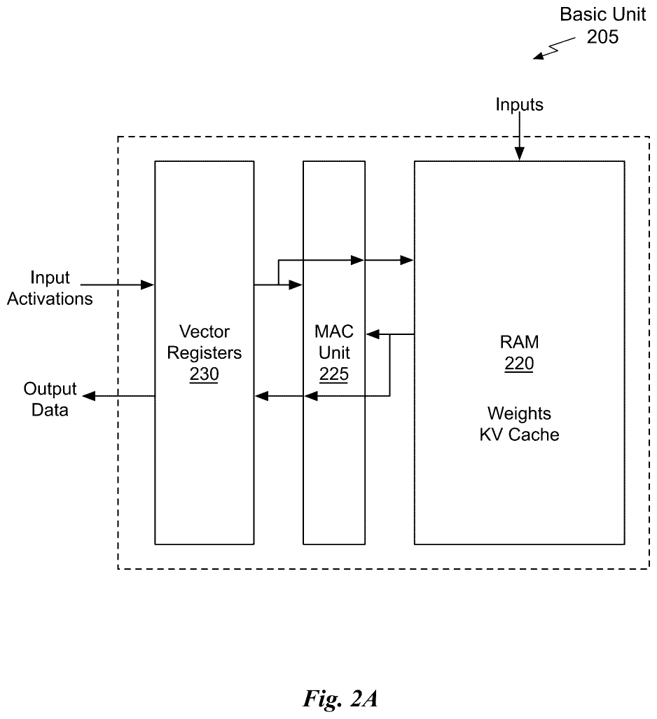

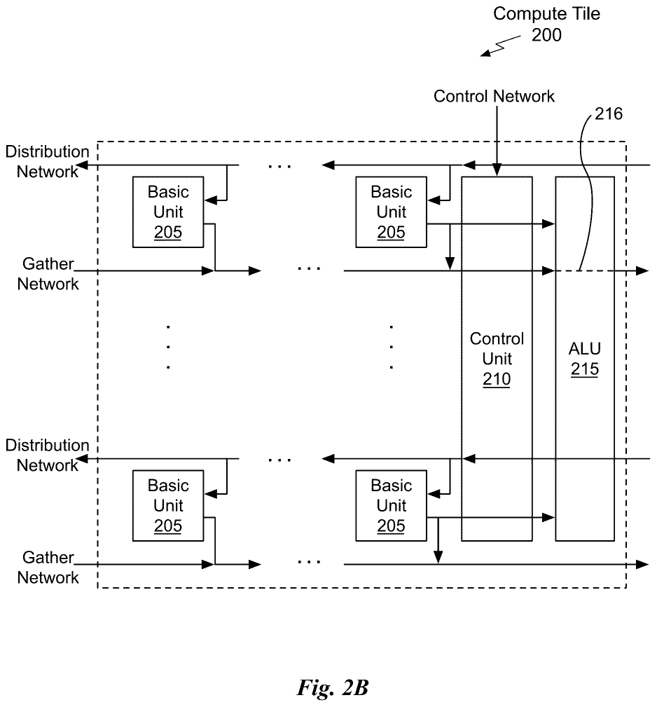

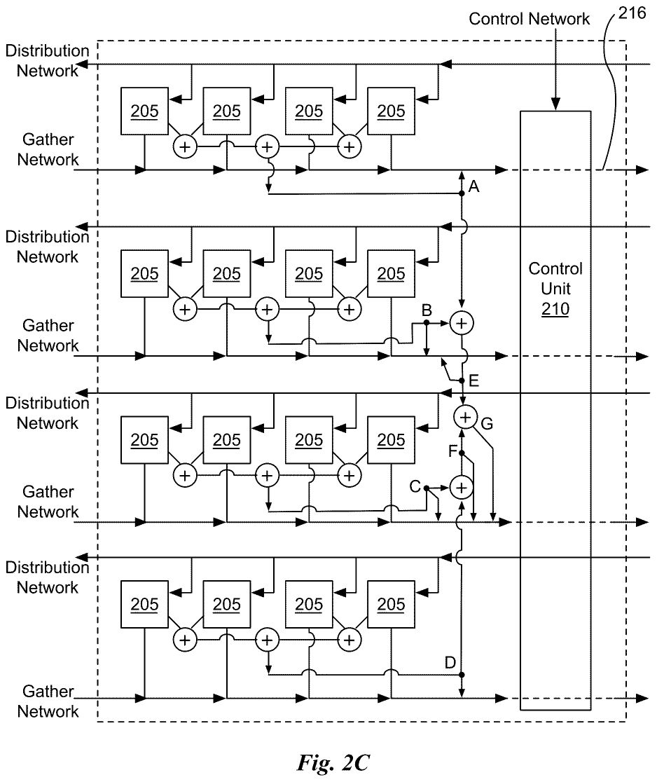

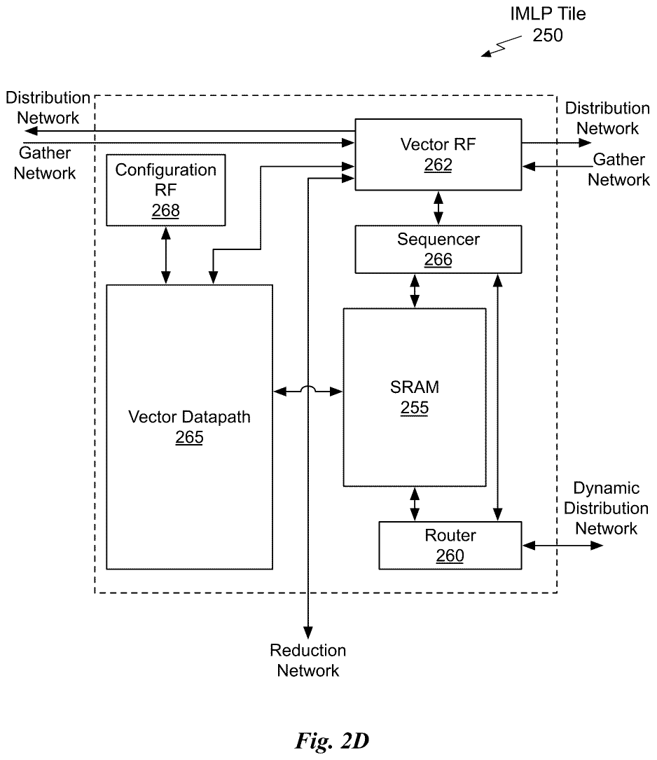

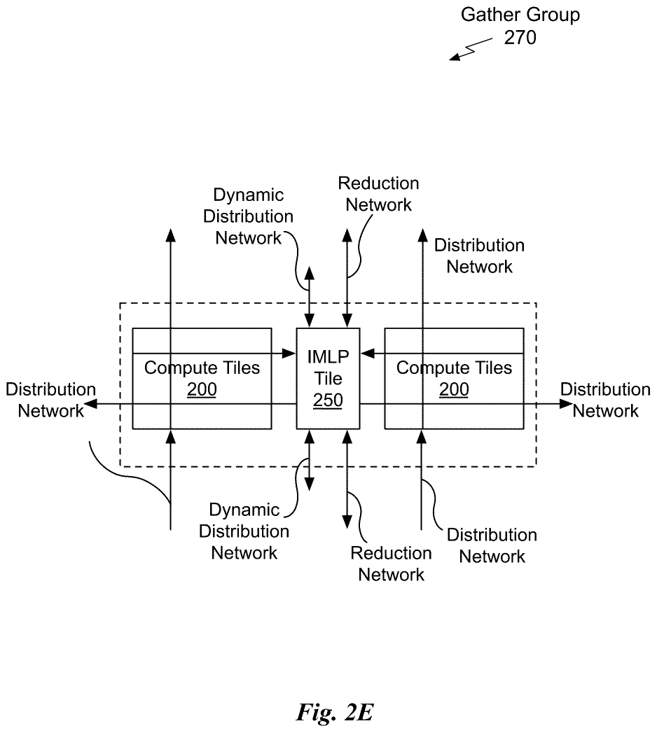

FIG. 2A illustrates a block diagram of an example basic unit 205, according to at least one embodiment. The basic unit 205 comprises vector registers 230, a MAC unit 225 (Multiply-Accumulate unit), and RAM 220. In an embodiment, the basic unit 205 is specifically designed to perform operations required for GEMM and related computations that are central to neural network inference (e.g., the decoding phase of LLM inference and other LLM computations).

The RAM 220 provides local on-chip storage for weights, KV cache data, and other intermediate data required for computations. In an embodiment, the RAM 220 comprises static RAM. By storing weights and KV cache data locally, the basic unit 205 reduces reliance on external memory, which improves energy efficiency and decreases data movement overhead. In an embodiment, the RAM 220 is optimized for high-speed access to minimize latency during matrix-vector operations. More specifically, in an embodiment the MAC unit 225 is located immediately adjacent to the sense amplifiers of the RAM 220. The close placement allows data read from the RAM 220 to be delivered directly from the sense amps to the MAC unit 225 with minimal wiring and propagation delay. By positioning the MAC unit 225 next to the sense amps, the architecture ensures rapid data transfer and efficient execution of multiply-accumulate operations, further reducing latency in matrix-vector computations required for neural network inference.

In an embodiment, the RAM 220 comprises a single SRAM macro that is 288 bits wide by 768 words. The 288b data stored in each row can contain 64 weights in NVFP 4 format—4bits per weight with an 8-bit scale factor for every 16 weights. Alternatively, the row can store other formats including Int4, Int8, FP4, FP8, MXFP4, MXFP6, MXFP8, BF16, and FP16. The data read from the RAM 220 can be input to the MAC unit 225, loaded into a vector register within the vector registers 230, or input to an arithmetic logic unit (not shown) to perform per-element operations.

The vector registers 230 serve as temporary storage for input activations and intermediate results input to the basic unit 205 and/or computed within the basic unit 205. The vector registers 230 store data computed by the MAC 225 and communicate through static connections within the compute tile to receive and transmit data, where the static connections are coupled to a configurable network external to the compute tile. In an embodiment, the vector registers 230 are coupled to the RAM 220. In an embodiment, data may be read from the RAM 220 and written to the vector registers 230 during the same cycle as data is read from the vector registers 230 and input to the MAC unit 225 and/or the RAM 220. In an embodiment, data may be written to the RAM 220 and read from the vector registers 230 during the same cycle as data is read from the vector registers 230 and input to the MAC unit 225 and/or the RAM 220. The vector registers 230 facilitate efficient data transfer between the RAM 220 and the computational components of the basic unit 205 and are configured to store activation vectors that are necessary for performing matrix-vector operations in the neural network layers.

The MAC unit 225 is implemented as the primary computational component of the basic unit 205 and includes an array of MAC elements to compute multiple MAC operations in parallel. In one embodiment, the MAC 225 is responsible for performing multiply-accumulate operations that are central to GEMM calculations. For example, the MAC 225 receives input data from the vector registers 230 and weights from the RAM 220 to compute partial results (for operations such as dot products), which are subsequently accumulated to produce the final output data. Accordingly, in an embodiment, the MAC 225 supports multiple precision formats, such as FP4 and FP8, thus optimizing performance and power consumption based on specific requirements, e.g., of a processed LLM layer.

In an embodiment, to optimize token latency for a single user (user tokens per second) the vector registers 230 and MAC unit 225 can be configured to use all 288b out of the RAM 220 on a single cycle. In such a configuration each vector register is 288 b (64 activations) wide and the 128-element MAC unit 225 multiplies the RAM output by either two repeated scalars (time accumulation), such as when multiple elements in the RAM output are multiplied by the same element from the vector register. In another example, element-wise multiplication is performed between elements in the RAM output and two selected vector registers (space accumulation) to generate two sets of 64 products. As specified by a control word, the products can be accumulated in time or space. When time accumulation is specified, each element of the vector read from the RAM 220 is multiplied by a pair of scalars selected from one of the vector registers. Output vector registers 230 are used to accumulate the 128 results. In an embodiment, the vector registers 230 includes eight registers. Additional bits are required to accumulate results without loss of precision, so two or more vector registers are used for each accumulation. When space accumulation is specified, a dot product is performed between the vector read from the RAM 220 and each source vector register. In an embodiment, 64 products generated by each set of 64 MACs in the MAC unit 225 are summed together and a single output is generated for each set. This output may be maintained with extra bits when it is produced and later converted to NVFP4 format, such as when the output is encoded as a vector. Operating to reduce in space, the basic unit 205 provides 64:1 bandwidth reduction. In an embodiment, the RAM 220 provides 288 Gb/s (36 GB/s) bandwidth so that the dot product reduces the bandwidth demand at the basic unit 205 level to 4.5 Gb/s (0.56 GB/s).

In an embodiment, the ratio of activations out of the SRAM (64) to the number of MAC elements (128) determines the natural batch size of the unit (2). The batch size can be varied by provisioning more or fewer MAC elements. With 64 MAC elements, the natural batch size is one, and with 256 MAC elements, the natural batch size is four. The ratio of MAC elements to memory bandwidth also determines the balance of area and power between memory and arithmetic. In other embodiments the SRAM macro may have different numbers of rows and columns. Similarly, in other embodiments greater or fewer numbers of vector registers and/or MAC elements may be included in the vector registers 230 and MAC unit 225, respectively.

In an embodiment, the basic unit 205 operates in a pipeline arrangement wherein input activations are received through the vector registers 230, processed by the MAC unit 225 along with weights or KV vectors stored in the RAM 220, and the resulting output data is generated and stored in the vector registers 230. This pipelined operation ensures high throughput and low latency, rendering the basic unit 205 well-suited for addressing the computational demands of neural network inference. To provide further bandwidth reduction, and to amortize the overhead of generating a control word and memory address for each basic unit 205, a number of basic units 205 can be combined into a compute tile.

FIG. 2B illustrates a block diagram of an example compute tile 200, according to at least one embodiment. The compute tile 200 comprises an array of basic units 205, control unit 210, and an arithmetic logic unit (ALU) 215. In an embodiment, the compute tile 200 comprises of an 8×8 array of 64 basic units 205. In an embodiment, the compute tile 200 comprises a 4×4 array of basic units 205 that each operate on a 1K-element vector each cycle.

The compute tile 200 functions as a primary processing unit for executing GEMM operations (e.g., within the LLM system 100 of FIG. 1A) and is configured to perform matrix-vector operations and to generate partial results that are subsequently transmitted to an IMLP tile for reduction operations via a configurable network. One or more IMLP tiles within a reduction group cooperate to generate an output for a reduction operation, where the number of IMLP and compute tiles in the reduction group varies based on a reduction dimension of the GEMM operation. The configurable network facilitates the transmission of partial results generated by the basic units 205 within the compute tile 200 to one or more IMLP tiles for subsequent processing. In an embodiment, the configurable network enables low-latency communication through direct routing of data to a register in the appropriate destination, thereby eliminating reliance on centralized memory. Moreover, the configurable network can be pre-configured based on the specific LLM being implemented, ensuring deterministic and efficient data movement. In an embodiment, the connections provided by the configurable network vary cycle to cycle, but in a pattern determined by the LLM.

In an embodiment, the configurable network comprises a gather network, a distribution network, and a reduction network. In an embodiment, the gather network provides a communication path between compute tiles 200 and between the compute tiles 200 and the IMLP tile. The static network within each compute tile 200 provides connections between the basic units 205 and the gather and distribution networks. The static network within each compute tile 200 also provides connections between the basic units 205 and the ALU 215. In an embodiment, the ALU 215 comprises an addition tree that sums together multiple outputs from the basic units 205 into a single output element. In an embodiment, the single output element is transmitted from the ALU 215 to the IMLP tile on the replacement connection 216. In an embodiment, the single output element is transmitted from the ALU 215 to individual basic units 205 (e.g., to the vector registers 230 within basic units 205) via the static network within the compute tile. In an embodiment, the distribution network provides activation inputs directly to each basic unit 205 (e.g., from an IMLP tile) through the static network within the compute tile 200. In an embodiment, the reduction network (not shown in FIG. 2B) provides a communication path between IMLP tiles.

FIG. 2C illustrates a block diagram of another example compute tile, according to at least one embodiment. As shown in FIG. 2C, the compute tile includes 16 basic units 205. In at least one embodiment, ALU 215 comprises the addition tree where results at different levels of the addition tree may be output to the gather network via replacement connections 216. Based on a reduction dimension, control unit 210 configures multiplexers (not shown) to couple intermediate results A, B, C, and D, intermediate results E and F, or result G to replacement connections 216. When accumulation in space is performed across all 16 basic units 205, result G comprises an accumulation of 1,024 products into a single sum. When accumulation in space is performed across 8 basic units 205, intermediate results E and F each comprise an accumulation of 512 products. When accumulation in space is performed across 4 basic units 205, intermediate results A, B, C, and D each comprise an accumulation of 256 products. For embodiments including less or more basic units 205, the addition tree scales accordingly along with the number of intermediate results that may be output via replacement connections 216.

The control unit 210 configures each basic unit 205 to perform calculations via control signals (not shown in FIG. 2B or 2C). Accordingly, the basic units 205 operate in parallel to compute partial results, with each unit leveraging the local storage associated with that unit to minimize data movement and improve energy efficiency. In an embodiment, the control unit 210 coordinates the operations of the basic units 205, managing the flow of data, including the distribution of input vectors and the retrieval of weights and cached K and V vectors from the local RAM 220. In addition, the control unit 210 configures the compute tile 200 to process inputs in parallel, thereby ensuring efficient utilization of the available computational resources.

In an embodiment, the control unit 210 receives a descriptor from a device level controller that defines operations to perform from a control network. In an embodiment, the control unit 210 comprises a state machine. In an embodiment, the descriptor includes instructions and the control unit 210 comprises a processor. The control unit 210 generates an address and a control word that is distributed to all basic units 205 in the compute tile 200. The address selects the memory row of the RAMs 220 to read each cycle. The control word selects registers in vector registers 230 to use and the operation to be performed each cycle. When accumulation in space is performed across all 64 (assuming an 8×8 array of) basic units 205 in the compute tile 200, the result accumulates 4,096 products into a single sum. As shown in FIG. 2C, multiple smaller accumulations in space may also be supported to produce multiple sums (assuming an 8×8 array of) basic units 205, such as accumulating 1024 products into 4 sums or 16 products into 128 sums. In an embodiment, the compute tile 200 extends the bandwidth reduction of the basic unit 205 from 64:1 to 4K:1. In an embodiment, the bandwidth of the RAMs 220 in the compute tile 200 is 2.3 TB/s and the bandwidth out of the compute tile 200 (for reductions in space) is 36 GB/s. In an embodiment, the compute tile 200 comprises 1.7 MB of memory and has 8K MAC elements.

In an embodiment, the control unit 210 specifies a horizontally microcoded instruction. Instructions can be repeated for a number of cycles. For example, to read from RAM 220 row 123 to row 154, computing dot products NVFP4 with vector registers VR3 and VR5 and putting the scalar results into scalar registers SR2 and SR3, the instruction is:

### Start: 123, Count: 32, Op: DOTFP4, Src1: VR3, Src2: VR5, Res1: SR1, Res2: SR2

The instruction set may also include control flow fields, and elementwise operation fields. The control flow instructions support conditional and unconditional branches. The control unit 210 may include instruction memory or a small instruction buffer with the instructions fetched from an instruction memory (not shown) in the compute tile 200. In an alternate embodiment, instructions are fetched from the memories of the basic units.

The control unit 210 also initiates the additional operations performed by the ALU 215. In at least one embodiment, ALU 215 performs additional operations such as scaling, format conversions, and element-wise reductions. These operations are often required for intermediary processing steps in neural network computations, including normalization or activation functions. The ALU 215 can be used to perform arithmetic and logical operations on the elements of two vector registers 230—or on one vector register and the output of a RAM 220—with the result being stored in a vector register. In an embodiment, the operations include reductions across the vector. These per-element operations are used, for example, to perform the soft-max calculation needed to implement a transformer attention head or to implement a non-linear function.

In an embodiment, the compute tile 200 is a highly optimized unit that is designed to meet the computational demands of LLM inference. By integrating local storage, parallel processing capabilities, and components of a configurable network, the compute tile 200 minimizes latency and energy consumption while supporting scalable and efficient matrix-vector operations.

During neural network inference, operations that have a reduction dimension include matrix-vector multiplications, dot products, and various reduction operations such as sum, max, and mean. These operations require aggregating partial results computed across multiple compute tiles, with the reduction dimension specifying how the computation is partitioned and combined. For example, in matrix-vector multiplication, each compute tile 200 processes a subset of the matrix rows or columns, and the partial results are reduced along the specified dimension to produce the final output vector. Similarly, operations like softmax, layer normalization, and attention mechanisms involve reductions across vectors or matrices, where the reduction dimension determines the scope and parallelism of the aggregation process.

The reduction dimension directly influences how compute processing is distributed across the LLI system. Specifically, the reduction dimension determines the number of compute tiles 200 that participate in a given matrix-vector operation, as each compute tile 200 may be responsible for processing only a portion of the reduction. A larger reduction dimension allows more compute tiles 200 to operate in parallel, thereby increasing throughput and reducing the time required to complete reductions such as sums, max, or mean operations. Conversely, a smaller reduction dimension may require more communication and coordination among tiles, as fewer compute tiles 200 are involved in the reduction, potentially increasing data movement and latency. By mapping the reduction dimension to the organization of compute tiles 200, the LLI system can flexibly allocate resources to match the computational requirements of different neural network layers, optimizing both performance and energy efficiency.

To facilitate operations that have a reduction dimension, one or more IMLP tiles can be provided to gather partial results from the compute tiles 200 and perform the necessary reduction operations, such as sum, max, or mean, along the specified dimension. The number of IMLP tiles employed for a given operation can be configured based on the reduction dimension, allowing the system to efficiently aggregate results and support varying levels of parallelism. By coordinating the reduction process, the IMLP tiles ensure that the aggregated outputs are produced with minimal latency and are ready for subsequent processing stages in the LLM pipeline.

FIG. 2D illustrates a block diagram of an example IMLP tile 250, according to at least one embodiment. The IMLP tile 250 comprises a vector datapath 265, configuration register file (RF) 268, vector register file (RF) 262, sequencer 266, SRAM 255, and a router 260. The IMLP tile 250 constitutes an important component of the low-latency inference (LLI) system and is designed to perform reduction operations and intermediate layer processing. In an embodiment, the IMLP tile 250 gathers partial results from compute tiles 200 and/or other IMLP tiles 250, processes the partial results, and distributes the outputs—to additional IMLP tiles 250 and/or compute tiles 200—for further neural network operations.

Within each IMLP tile, the reduction dimension is used to determine the quantity of input activations or partial results received from the compute tiles 200 and the manner in which the reduction logic is applied. A vector datapath within the IMLP tile is configured to perform reductions across the specified dimension, aggregating data from multiple sources in parallel. This configuration allows the IMLP tile to process large-scale reductions in an efficient manner by utilizing local resources and programmable reduction logic, ensuring that the final reduced result reflects the aggregation required by the reduction operation.

The vector RF 262 serves as temporary storage for input activations, intermediate results, and output activations. In an embodiment, the vector RF 262 facilitates efficient data access and transfer to other components within the IMLP tile 250, thereby ensuring low-latency processing of vector operations. Input activations may be received from the configurable network and stored in the vector RF 262 for subsequent processing. Output activations stored in the vector RF 262 and resulting from reduction operations may be transmitted through the configurable network. Other data may be received from the dynamic distribution network via the router 260 and stored in the vector RF 262 for subsequent processing.

In an embodiment, the sequencer 266 is coupled to the vector RF 262 to coordinate the execution of operations within the IMLP tile 250. Specifically, the sequencer 266 manages the flow of data between various components of the IMLP tile 250, ensuring that input activations, intermediate results, and output activations are processed in the correct sequence. The SRAM 255 provides local storage for weights, intermediate data, and configuration parameters used during processing. By storing data locally, the SRAM 255 minimizes reliance on external memory, which reduces data movement and improves energy efficiency. In an embodiment, the SRAM 255 is directly accessible by the vector datapath 265 and other components within the IMLP tile 250.

The vector datapath 265 functions as the primary computational unit of the IMLP tile 250. In an embodiment, the vector datapath 265 performs vector operations such as reductions (e.g., sum, max, mean) and transformations (e.g., normalization, activation functions) that are significant for intermediate layer processing. Accordingly, the vector datapath 265 processes data retrieved from the Vector RF 262 and SRAM 255, generating results which are either stored back in the Vector RF 262 or transmitted to other tiles. The configuration RF 268 stores configuration parameters that define the operational behavior of the vector datapath 265. These parameters, which may include settings for reduction operations, activation functions, or other processing tasks, ensure that the IMLP tile 250 can be dynamically programmed to handle a variety of LLM workloads, thereby providing both flexibility and scalability.

The gather network, reduction network, and distribution network (which collectively provide a configurable network) provide for deterministic communication of intermediate results from compute tiles 200 to IMLP tile 250, of locally reduced results between different IMLP tiles 250, and of final results of one processing stage as inputs to compute tiles 200 for a subsequent processing stage. The router 260 facilitates communication between the IMLP tile 250 and other devices through the dynamic distribution network. The router 260 is configured to transmit and receive data via the dynamic distribution network, thus allowing the IMLP tile 250 to participate in both deterministic and data-dependent communication patterns.

In an embodiment, the IMLP tile 250 represents a highly integrated and programmable unit designed to enhance intermediate layer processing for LLM inference. The combination of local storage, computational capabilities, and flexible configuration facilitates efficient and scalable handling of LLM operations. The IMLP tiles 250 may perform chip-level reduction operations, such as sum and max, gathering inputs from multiple compute tiles 200 and distributing the results to one or more compute tiles 200.

FIG. 2E illustrates a block diagram of an example LLI gather group 270, according to at least one embodiment. The LLI gather group 270 represents a primary computational unit and comprises compute tiles 200 and an IMLP tile 250. In an embodiment, the LLI gather group 270 comprises two sets of eight compute tiles 200 positioned on either side of an IMLP tile 250. This arrangement facilitates efficient processing of matrix-vector and reduction operations, e.g., for common LLMs.

In one embodiment, the compute tiles 200 are designed to perform GEMM operations and generate partial results that are subsequently transmitted to the IMLP tile 250 for further processing. In an embodiment, the partial results generated by the compute tiles 200 are “gathered” by a configurable network as they are transmitted for input to the IMLP tile 250. In an embodiment, the IMLP tile 250, serving as the intermediate layer processing unit within the LLI gather group 270, is configured to perform reduction operations including sum, max, and mean, as well as other vector operations like normalization, quantization, and activation functions, thereby enabling efficient processing and aggregation of the partial results received from the compute tiles 200. In one embodiment, one or more gather groups 270 are organized as a reduction group based on a reduction dimension of the reduction operation. The IMLP tile 250 may receive inputs to the reduction and/or vector operations from other IMLP tiles 250 through the configurable network. The processed results may then be output by the IMLP tile 250 and distributed by the configurable network to compute tiles 200 (and the basic units 205 thereof) for subsequent processing stages.

In an embodiment, the LLI gather group 270 incorporates two distinct networks to facilitate data movement and communication. The configurable network is configured for deterministic, pre-configured data transmission both within and between the compute tiles 200 and the IMLP tile 250. On the other hand, the dynamic distribution network is employed to handle data-dependent communication and facilitate routing across tiles and chips, thereby enabling flexibility and scalability for various LLM configurations. Thus, by integrating compute tiles 200 and the IMLP tile 250 within the LLI gather group 270, the system achieves a balance between localized computation and efficient data movement. The architecture of the LLI gather group 270 reduces reliance on external memory, minimizes data movement overhead, and supports scalable, low-latency neural network inference.

### Configurable Network

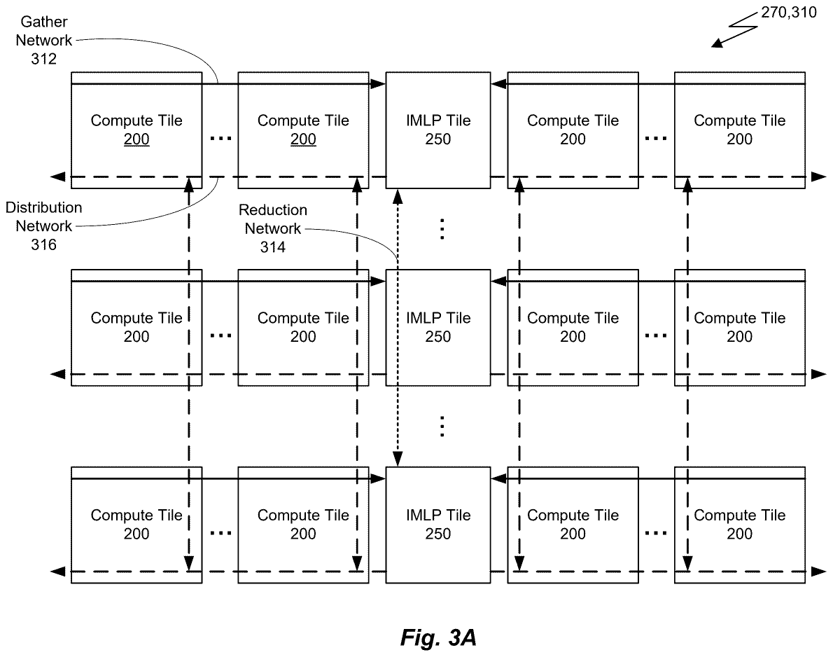

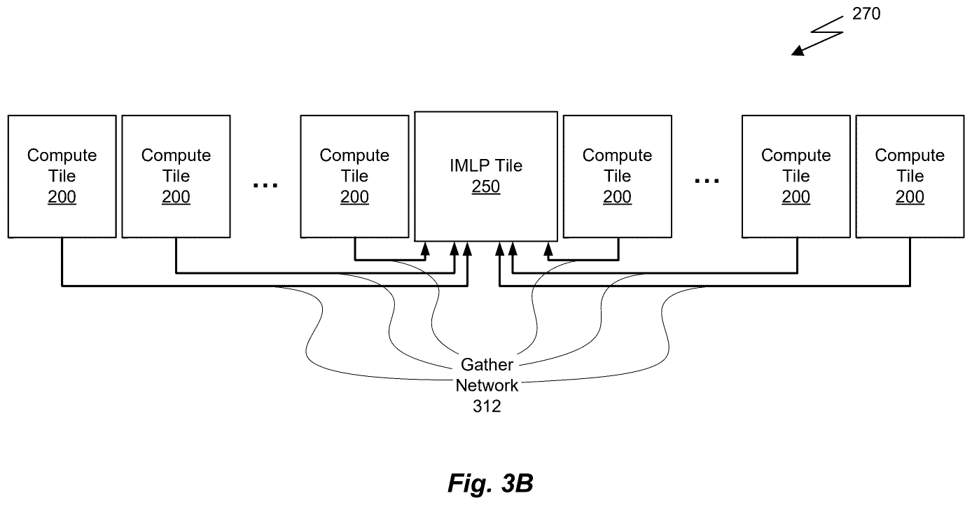

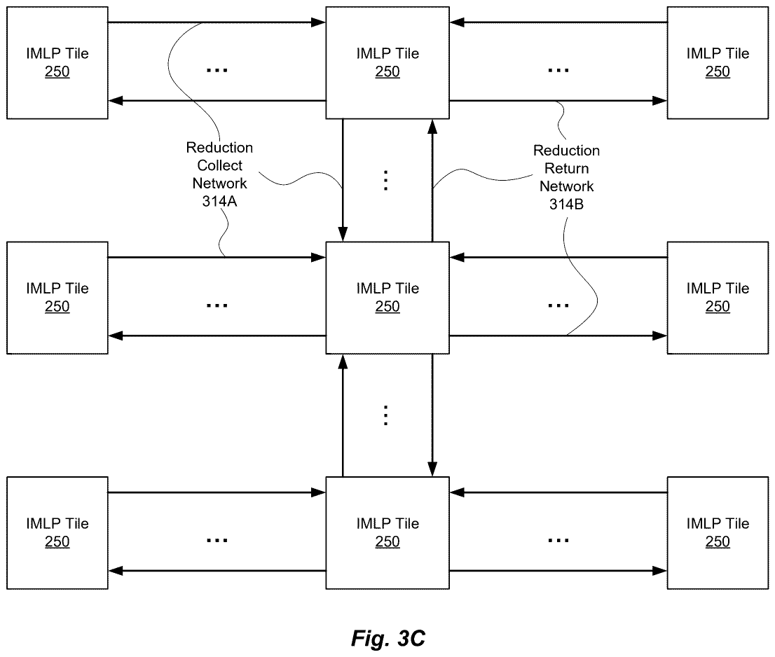

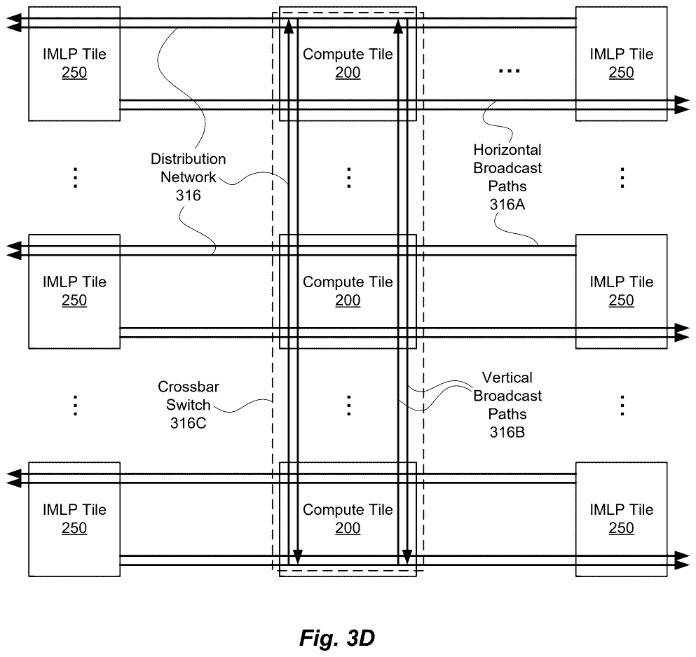

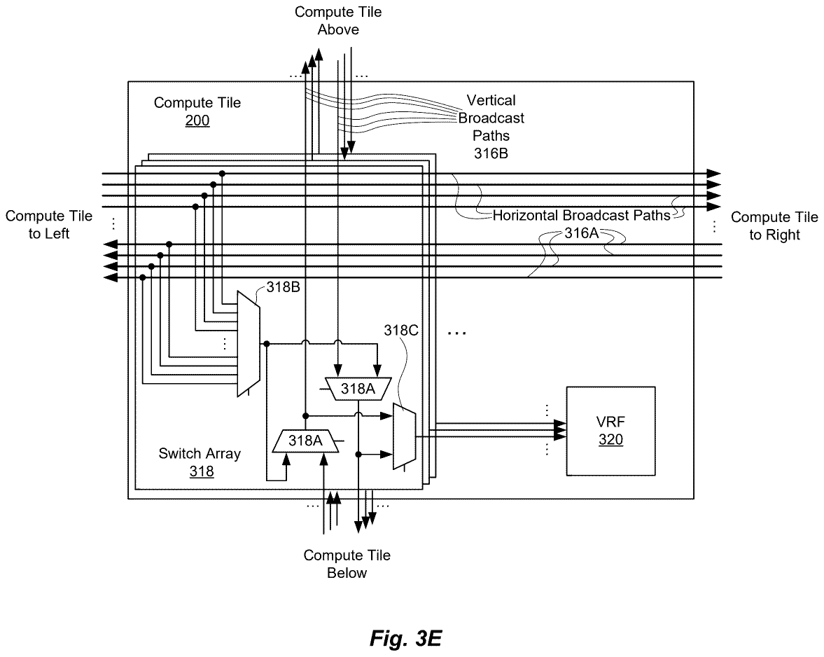

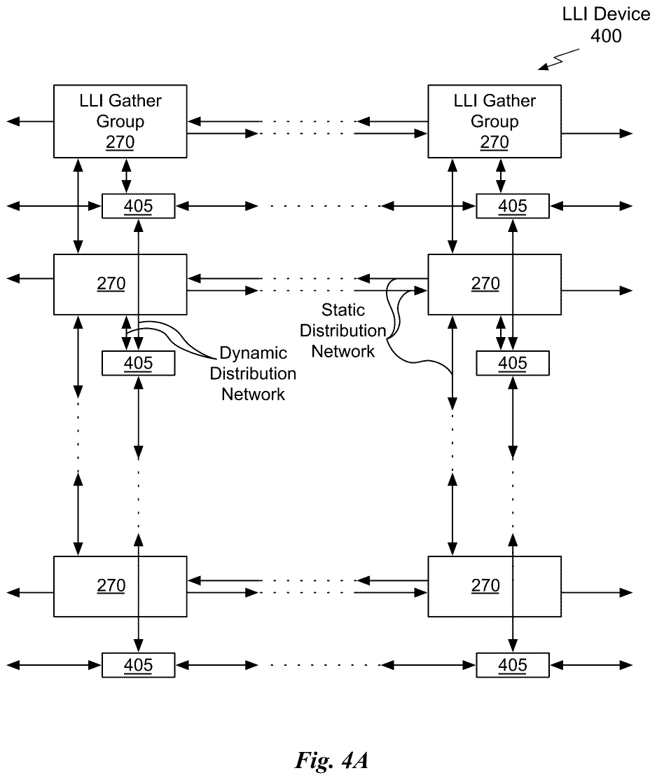

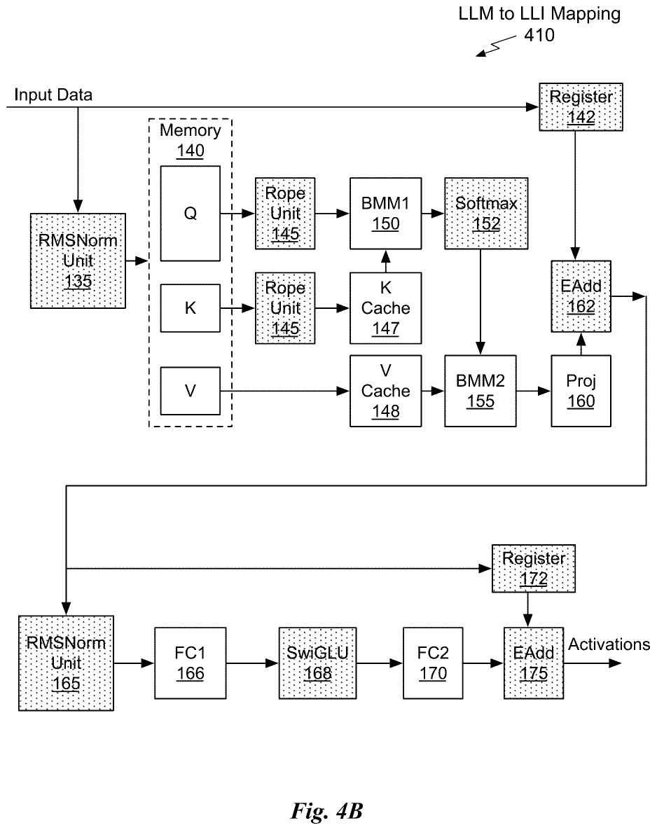

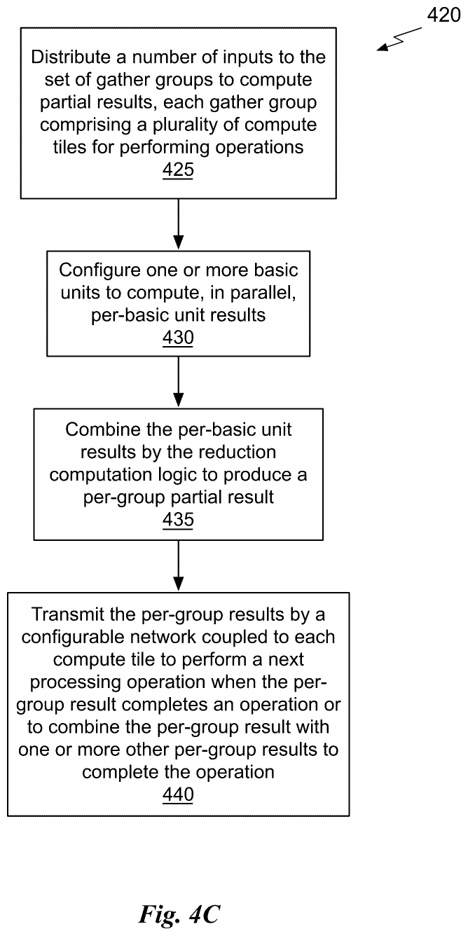

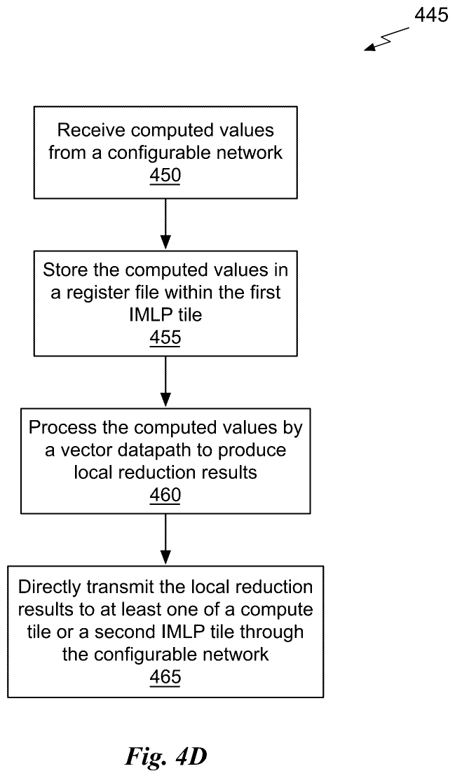

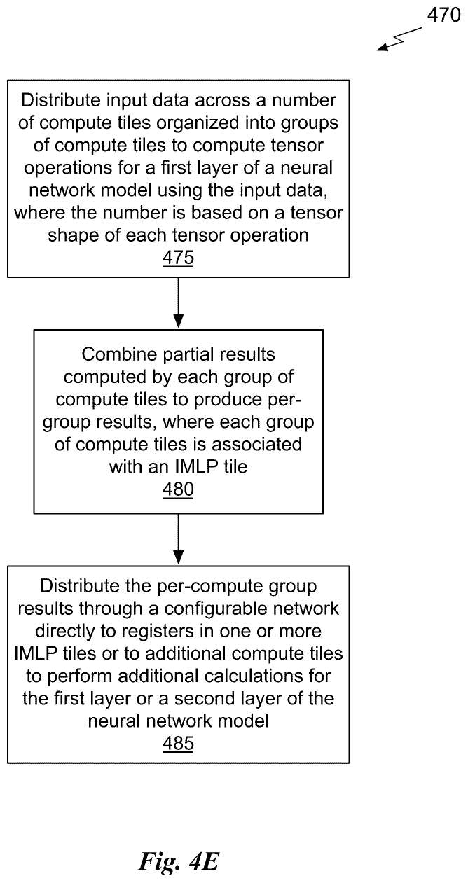

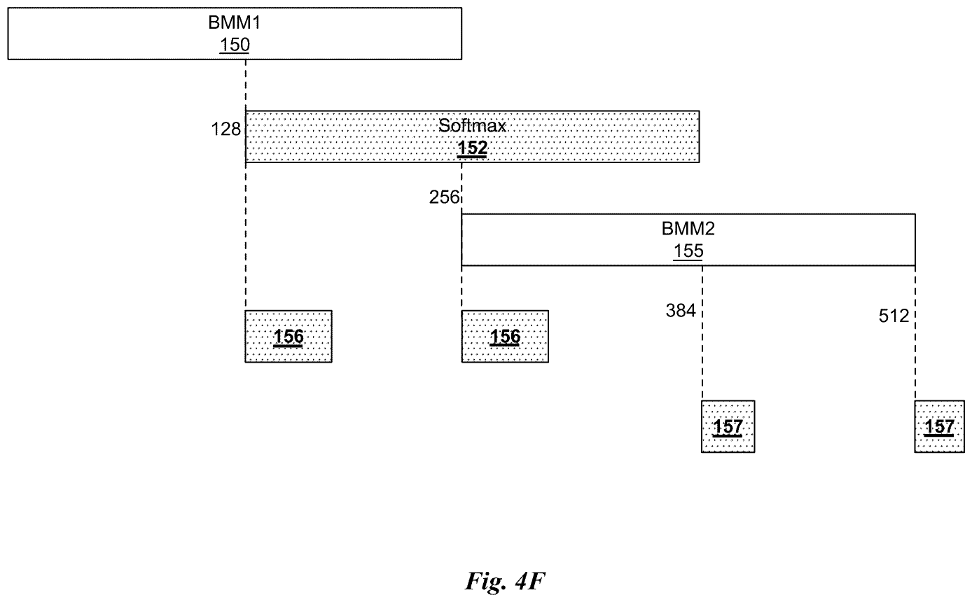

FIG. 3A illustrates a block diagram of a column of LLI gather groups 270 (e.g., of an LLI system such as LLI device 400 of FIG. 4A) and a configurable network 310 connecting different tiles within the same gather group and connecting tiles of different gather groups, according to at least one embodiment. Each LLI gather group 270 comprises a plurality of compute tiles 200 and an IMLP tile 250. In an embodiment, the number of compute tiles 200 within the LLI gather group 270 is fixed (static) while the number of LLI gather groups 270 that are configured to perform a reduction operation as a reduction group may change (is dynamic).

Configurable network 310 facilitates direct, deterministic data movement and provides cycle-matched and pipelined delivery of results of one processing stage directly to compute tiles 200 that require those results as inputs to a subsequent processing stage. A processing stage, as used herein, can refer to any coherent block of computation that requires input (e.g., input activations), performs a defined operation or set of operations (e.g., GEMM operations, softmax, normalization, etc.), and produces output (e.g., output activations). A processing stage can map, e.g., to GEMM operations, to reduction or normalization operations (e.g., a softmax or RMSNorm operation), or to a combination thereof. Configurable network 310 thereby eliminates the need for intermediate storage in centralized memory (such as SRAM or DRAM), potentially reducing long-distance on-chip and off-chip data movement.

Configurable network 310 includes gather network 312, reduction network 314, and distribution network 316. Gather network 312 connects compute tiles 200 within each respective LLI gather group 270 to the IMLP tile 250 of the respective LLI gather group 270. Reduction network 314 connects IMLP tiles 250 of adjacent LLI gather groups 270 within the column. While not shown in FIG. 3A, in one or more embodiments, reduction network 314 additionally connects IMLP tiles 250 of different columns of LLI gather groups 270. In one or more embodiments, reduction network 314 connects IMLP tiles across different LLI chips (e.g., different LLI devices 400). Distribution network 316 connects compute tiles 200 within each respective LLI gather group 270 and further connects compute tiles 200 of adjacent LLI gather groups 270 within each column. Each of gather network 312, reduction network 314, and distribution network 316 are physically separate and pipelined.

Configurable network 310 reduces latency by exploiting static communication patterns, e.g., communication patterns that are dependent on the configuration of a neural network used for inference and on the context length specified for the neural network, where the context length influences the size and/or shape of the tensors. Static communication patterns are pre-determined for respective processing stages (e.g., attention) of layers of a neural network. Configurable network 310 is preconfigured—in accordance with the respective processing stage—to transmit results of computations performed within compute tiles 200 and/or IMLP tiles 250 directly compute tiles 200 (and basic units 205 thereof) that require said results for a subsequent processing stage. Configurable network 310 is then (re-)configured for the subsequent processing stage.

In one or more embodiments, configurable network 310 is configured for a given processing stage by programming relevant control logic within the compute tiles 200 and IMLP tiles 250 to establish the static communication patterns for that stage. In at least one embodiment, the configuration process involves a hardware state machine (which can include, components of control units 210 of compute tiles 200 and configuration RFs 268 of IMLP tiles 250) that receives one or more descriptors specifying desired data movement and routing. In at least one embodiment, the descriptors are provided by a device-level controller and delivered to compute tiles 200 and IMLP tiles 250 via the dynamic distribution network. Upon receiving the descriptors, the control logic sets appropriate switches and routing elements (e.g., within distribution network 316) to implement predetermined reduction and broadcast/multicast patterns. In one or more embodiments, the configuration is performed by a lightweight, instruction-based processor that programs the network for each processing stage. In one or more embodiments, the configuration is performed by microcoded control.

Distributing compute operations spatially across different compute tiles 200, distributing reduction operations spatially across different IMLP tiles 250, and using the configurable network 310 to gather and distribute results provides several key advantages, e.g., during neural network inference. Across chip data transfers (e.g., to centralized memory) are avoided and communication delays are reduced, thereby enabling faster layer-to-layer processing. Reliance on high-bandwidth, power-hungry global memory accesses is limited, thereby improving energy efficiency. Furthermore, pre-configured, deterministic data movement ensures predictable data flow and enables strict latency requirements to be met.

FIG. 3B illustrates a block diagram of a gather network 312 of an LLI gather group 270 of an LLI system (e.g., LLI device 400 of FIG. 4A), according to at least one embodiment. Gather network 312 is a dedicated, pipelined, and configurable interconnect that provides for direct transfer, to IMLP tile 250, of intermediate results produced by compute tiles 200. The intermediate results can then be reduced, normalized, or otherwise processed by IMLP tile 250 as required by a target workload. In one or more embodiments, gather network 312 includes, in addition to one or more wires that provide communication paths from each compute tile 200 to the IMLP tile 250 of the LLI gather group 270, one or more wires within each compute tile 200 that provide communication paths between components thereof, e.g., basic units 205 (and the vector registers 230 and/or MAC units 225 thereof) and ALU 215.

Gather network 312 provides direct, cycle-matched delivery from compute tiles 200 to IMLP tile 250. To perform certain GEMM operations (e.g., BMM1 150, BMM2 155, FC1 166, and FC2 170 during neural network inference), each compute tile 200 produces an intermediate result (e.g., a partial sum or output activation-typically provided in a high-precision format (e.g., FP32). Gather network 312 is provisioned with a bandwidth and structure sufficient to deliver the intermediate results to IMLP tile 250 in the same cycle or macro cycle in which they are generated. In an embodiment, gather network 312 includes one or more pipeline stages to transmit the intermediate results from compute tiles 250 positioned further from the IMLP tile 250 compared with other compute tiles 200. As a result, no centralized storage (such as L2 cache or DRAM) is required for the intermediate results, and only physical wire propagation delay is incurred (which can be hidden through pipelining and reduced via physical design). The direct, deterministic data flow provided by the gather network 312 removes bottlenecks and facilitates, e.g., low-latency, high-throughput neural network inference.

FIG. 3C illustrates a block diagram of a reduction network 314, according to at least one embodiment, of an LLI system (e.g., LLI device 400 of FIG. 4A) that includes an array of LLI gather groups 270 arranged in rows and columns. Reduction network 314 is a second dedicated, pipelined, and configurable interconnect that connects IMLP tiles 250 of different LLI gather groups 270, ensuring deterministic and low-latency communication therebetween. In one or more embodiments, reduction network 314 includes, in addition to one or more wires that provide communication paths between IMLP tiles 250, one or more wires within each IMLP tile 250 that provide communication paths to and between components thereof (e.g., vector RF 262 and vector datapath 265).

Reduction network 314 enables aggregation and reduction of local results, thereby supporting operations that require global reductions, such as softmax, normalization, and scaling. Reduction network 314 is divided into two components: reduction collect network 314A and reduction return network 314B. Reduction collect network 314A aggregates local results (e.g., partial sums, local maxima, or other statistics) from multiple IMLP tiles 250. Each IMLP tile 250 generates locally reduced results by performing local reductions on results received from compute tiles 200 of an LLI gather group 270 via gather network 312. Such local reductions include, e.g., summing partial results (e.g., for a GEMM with a large reduction dimension—such as BMM2 155), finding local maxima, or performing other vector operations. Reduction collect network 314A also forwards locally reduced results to adjacent IMLP tiles 250, enabling further reductions at each hop. For certain reduction operations, the reduction process continues until a global reduction result is computed at one or more designated IMLP tiles 250 (e.g., a root IMLP tile 250). Once the global reduction is complete, reduction return network 314B returns the final reduced value (e.g., a global sum or maximum) back to all IMLP tiles 250, enabling each IMLP tile 250 to use the global reduction result for further processing, such as scaling or normalization. For example, the global maximum can be used to normalize a product activation vector of a GEMM operation, e.g., as described below.

In one or more embodiments, reduction network 314 connects IMLP tiles 250 of different gather groups 270 in a hierarchical structure to facilitate global reduction operations while providing tapered bandwidth to reduce data movement and enhance performance. In at least one embodiment, reduction network 314 connects IMLP tiles 250 in a tree structure, wherein individual IMLP tiles 250 serve as nodes of the tree and wires of the reduction network 314 that provide links/connections between IMLP tiles 250 serve as edges of the tree. IMLP tiles 250 that serve as leaf/child nodes compute local reductions (which are collected at parent nodes by reduction collect network 314A), and an IMLP tile 250 that serves as the root node computes a global reduction (which is returned to leaf/child nodes via the reduction return network 314B). The structure of the tree is determined in accordance with a respective processing stage, e.g., a depth of the tree can be determined based on a reduction dimension of a tensor operation. The tree structure provides bandwidth that is higher locally (i.e., immediately adjacent child nodes, or upstream in the collect direction/downstream in the return direction) and lower globally (i.e., adjacent the root node, or downstream in the collect direction/upstream in the return direction).

The reduction network 314 is provisioned with sufficient bandwidth to match the output bandwidth of the IMLP tiles 250 and ensure that locally reduced results are forwarded to subsequent IMLP tiles 250 at the same rate at which they are generated. Each IMLP tile 250 comprises a vector datapath 265 that retrieves data stored in Vector RF 262 and/or SRAM 255 and performs operations such as reductions (e.g., sum, max, mean) and transformations (e.g., normalization, activation functions). The reduction network 314 is provisioned with a bandwidth and structure matched to the output rate of the IMLP tiles 250 so that each locally reduced result can be transferred to another IMLP tile 250 in the same cycle or macro cycle in which it was generated.

In one or more embodiments, a first processing stage includes both a first GEMM operation and a reduction operation, and a second (subsequent) processing stage includes a second (subsequent GEMM operation). The first GEMM operation requires a first number of cycles (e.g., 128 cycles) to complete. Every cycle, each respective IMLP tile 250 produces (e.g., via vector datapath 265) and stores (e.g., at vector RF 262) one or more output activations. After the first number of cycles is complete, each respective IMLP tile 250 stores one or more subvectors of output activations (i.e., the output activations produced each cycle by the respective IMLP 250 are accumulated to form one or more subvectors). Following the first GEMM operation, the reduction operation is carried out via reduction network 314 and IMLP tiles 250. To perform the reduction operation, each respective IMLP tile 250 computes local results, reduction collect network 314A aggregates local results, a root IMLP tile 250 computes a global reduction result, reduction return network 314B distributes the global reduction result to all IMLP tiles 250, and each respective IMLP tile 250 computes normalized output activations using the global reduction result. Reduction collect and reduction return networks 314A and 314B are provisioned such that local, intermediate, and global reduction results are forwarded at the same rate at which they are produced, and as a result, no centralized storage (e.g., cache or DRAM) is required for storing local, intermediate, or global reduction results. The total reduction latency is determined by a combination of the depth of the reduction network and physical wire delay.

FIG. 3D illustrates a block diagram of a distribution network 316 of an LLI system, according to at least one embodiment, and FIG. 3E illustrates a block diagram of a portion of distribution network 316, according to at least one embodiment, at an individual compute tile 200. Distribution network 316 is a third dedicated, pipelined, and configurable interconnect that delivers results (or a portion thereof) of one processing stage to compute tiles 200 (and basic units 205 thereof) that require those results (or portion thereof) as input to a subsequent processing stage. Distribution network 316 is physically separate from gather network 312 and reduction network 314, and is designed for deterministic, low-latency, high-bandwidth, and cycle-matched broadcasting/multicasting from one or more (e.g., all) IMLP tiles 250 to one or more (e.g., all) compute tiles 200 of an LLI system (e.g., the LLI device 400 of FIG. 4A). As a result, no centralized storage (e.g., cache or DRAM) is required for storing results between processing stages.

Distribution network 316 includes one or more buffered and pipelined communication paths that span an array of compute tiles 200 (i.e., one or more rows of compute tiles 200 and one or more columns of compute tiles 200) formed by an array of LLI gather groups 270 (as provided, e.g., by LLI device 400 of FIG. 4A). The communication paths provide for communication between all IMLP tiles 250 and all compute tiles 200 in the one or more rows of compute tiles 200 (i.e., horizontal broadcast paths 316A from each IMLP tile 250) and provide for communication between one or more adjacent compute tiles 200 in each of the one or more columns of compute tiles 200 (i.e., vertical broadcast paths 316B connected to the horizontal broadcast paths). In one or more embodiments, distribution network 316 additionally includes one or more wires that provide for communication to and between components of each compute tile 200 (e.g., one or more wires that, within each compute tile 200, connect to each basic unit 205 and to vector registers 230 thereof) and for communication to and between components of each IMLP tile 250. In an embodiment, distribution network 316 includes one or more pipeline stages along the communication paths and buffering to support broadcast and/or multicast communication to multiple compute tiles 200.

Distribution network 316 provides for m-to-n multicasting from IMLP tiles 250 to compute tiles 200 (m is a number of IMLP tiles 250, and n is a number of compute tiles 200). Horizontal broadcast paths 316A distribute outputs computed by IMLP tiles 250 (e.g., activations) to respective sets of vertical broadcast paths 316B in each respective column of the one or more columns of compute tiles 200, and each respective set of vertical broadcast paths 316B connects respective sets of horizontal broadcast paths (i.e., in each respective row of the one or more rows of compute tiles 200) to each compute tile 200 in a respective column of compute tiles 200. In at least one embodiment, the number of horizontal broadcast paths 316A in each respective row of compute tiles 200 is determined based on a number of IMLP tiles 250 per row of compute tiles. In at least one embodiment, the number of horizontal broadcast paths 316A in each respective row of compute tiles 200 is further based on a typical reduction dimension of target GEMM operations and/or a computational bandwidth of individual compute tiles 200. In at least one embodiment, the number of vertical broadcast paths 316B in each respective column of compute tiles 200 is equal to a number of horizontal broadcast paths 316A per row of compute tiles 200 multiplied by a number of rows of compute tiles 200. In at least one embodiment, the number of vertical broadcast paths 316B is reduced (i.e., from the number of horizontal broadcast paths 316A per row of compute tiles 200 multiplied by the number of rows) by a reduction factor. In at least one embodiment, the reduction factor is determined based on a typical reduction dimension of target GEMM operations.

In an embodiment, distribution network 316 includes a crossbar switch 316C for each respective column of compute tiles 200 to connect all horizontal broadcast paths 316A (i.e., inputs) to all vertical broadcast paths 316B in the respective column of compute tiles 200 (i.e., outputs). The horizontal broadcast paths 316A come directly from IMLP tiles 250 and are distributed to every compute tile 200 in a row. As shown in FIG. 3E, each crossbar switch 316C includes, for each compute tile 200, a (multiplexer) switch array 318 for each respective vertical broadcast path 316B. The switch array 318 enables the respective vertical broadcast path 316B to select from any horizontal broadcast path 316A. Each switch array 318 includes (i) a set of first-level multiplexers 318A that select for either forwarding data from an adjacent tile (in the vertical direction) or driving data from a horizontal broadcast path 316A, (ii) a second-level multiplexer 318B that selects a specific horizontal broadcast path 316A as input to the set of first level multiplexers 318A, and (iii) a third-level multiplexer 318C that selects, for each vertical broadcast path 316B, input from a northbound or southbound wire bundle to provide as output to a local vector register file (VRF) 320 (comprising the register files 230 within the basic units 205 of a corresponding compute tile 200). The switch arrays 318 in the compute tiles 200 of a column thereby select, via first level multiplexers 318A, sets of horizontal broadcast paths 316A corresponding to respective rows of compute tiles 200, and, via second level multiplexers 318B, specific horizontal broadcast paths 316A from the sets of horizontal broadcast paths 316A selected by first level multiplexers 318A. Control logic (e.g., as executed by control units 210 of respective compute tiles 200) configure the switch arrays 318—and thereby crossbar switches 316C—to ensure correct mapping of source IMLP tiles 250 to destination compute tiles 200. The switch arrays 318 thereby collectively select appropriate inputs for each compute tile 200 in accordance with a broadcast or multicast pattern predetermined for a current processing stage.

Inputs to VRF 320 are selected from northbound and southbound wire bundles of respective vertical broadcast paths 316B via third-level multiplexers 318C. VRF 320 includes vector registers 230 of basic units 205 of compute tile 200 and additionally includes an array of demultiplexers that select, from the vertical broadcast paths 316B, an input for each vector register 230. In at least one embodiment, each demultiplexer receives inputs from all vertical broadcast paths 316B. In at least one alternative embodiment, each demultiplexer receives inputs from only a subset of vertical broadcast paths 316B. Control logic (e.g., as executed by control units 210 of respective compute tiles 200) configures respective demultiplexers to ensure the correct mapping of vertical broadcast paths 316 to vector registers 230 of VRF 320 (e.g., to ensure correct activations are loaded into correct vector registers 230 of correct basic units 205). Activations transmitted via distribution network 316 are thereby routed to appropriate vector registers 230 of basic units 205.

Distribution network 316 is configurable to provide—for a respective processing stage—static multicast patterns pre-determined for particular GEMM operations. For example, during neural network inference, output of a first GEMM operation, e.g., BMM1 150, BMM2 155, FC1 166, or FC2 170, serves (e.g., after being reduced) as input to a subsequent operation, and distribution network 316 is configurable based on spatial distributions of computations corresponding to the first GEMM operation and to the subsequent operation to an array of LLI gather groups 270. In one or more embodiments, during every compute cycle of a number of compute cycles over which computations corresponding to the first GEMM operation are performed, IMLP tiles 250 generate one or more activations that form subvectors, and distribution network 316 simultaneously multicasts the subvectors to destination compute tiles 200. Crossbar switches 316C in columns of compute tiles 200 are preconfigured to map source IMLP tiles 250 to destination compute tiles 200 in corresponding columns, and the configuration of crossbar switches 316C remains static for the duration of the first GEMM operation (the mapping between source IMLP tiles 250 and destination compute tiles 200 does not change). At each compute tile 200, respective demultiplexers of VRF 230 are preconfigured to map vertical broadcast paths 316B to vector register addresses of the collection of vector registers 230 of the basic units 205 of the compute tile 200. Distribution network 316 thereby provides a static communication pattern for the entire GEMM operation, single subvectors are written to destination vector registers 230 for each compute cycle, and the subvectors are concatenated, over multiple cycles, at vector registers 230 to form one or more product vectors of the GEMM—which serve as input to the subsequent operation.

In one or more embodiments, GEMM operations with dimensions M×N×K (M is the “batch” dimension, N is the “activation” dimension, and K is the “reduction” dimension such that M×K corresponds to the input activation matrix, N×K to the weight matrix, and M×N to the output activation matrix) are mapped to one or more LLI gather groups 270. Configurable network 310 provides a datapath for each basic unit 205 of the one or more LLI gather groups 270, thereby spatially mapping subsets of the M×N×K dimensions to enable strong scaling. For example, for four columns of 32 rows of LLI gather groups 270, each LLI gather group 270 including 16 compute tiles 200, each compute tile 200 including 16 basic units 205, each basic unit 205 being 64 elements wide with a batch factor of 2, the configurable network 310 provides 32K total datapaths, each of which processes M×N×K dimensions of 2×1×64. In various embodiments, basic units 205 are provisioned with various numbers of MAC units 225. Provisioning basic units 205 with multiple MAC units 225 allows multiple outputs to be computed each cycle. Configurable network 310 scales according to the batch factor (a batch factor of 2 results in twice the bandwidth of a batch factor of 1 because twice as many outputs are computed per cycle by MAC units 225).

In one or more embodiments, an example LLI chip includes a configurable network 310 and four columns of 32 rows of LLI gather groups 270, each LLI gather group 270 includes 16 compute tiles 200 per IMLP tile 250 (i.e., the LLI system includes 2K compute tiles or 128 gather groups 270), each compute tile 200 includes 16 basic units 205, and each basic unit is 64 elements wide (i.e., each compute tile 200 is 1K elements wide). The distribution network 316 includes: (i) for each respective row of the 32 rows of LLI gather groups 270, 64 horizontal broadcast paths 316A, each being one element wide (i.e., one horizontal broadcast path for each compute tile 200 in the respective row) and (ii) for each of the 64 columns of compute tiles (formed from 4 columns of LLI gather groups 270), 64 vertical broadcast paths 316B, each being one element wide. Distribution network 316 further includes, for each of the 64 columns of compute tiles, a 2K×64 crossbar switch 316C.

In one or more embodiments, computations corresponding to first and second GEMM operations (e.g., BMM1 150, BMM2 155, FC1 166, or FC2 170) are spatially distributed to compute tiles 200 (i.e., the first and second GEMM operations are mapped to the example LLI chip), and distribution network 316 of configurable network 310 is configured based on the spatial distributions of computations. The M, N, and K dimensions of the GEMM operations are distributed both spatially and temporally, and the spatial and temporal distributions are selected to limit data movement overhead and improve overall system throughput.

According to an embodiment, a 1×8K×8K GEMM operation is mapped to the example LLI chip, and the basic units 205 of the example LLI chip have a batch factor of 1. The first GEMM operation multiplies an 8×8K weight matrix by an 8K input activation vector to produce an 8K product activation vector. The 8K×8K weight matrix is divided into 256 slices that each contain 32 rows, and each respective slice is distributed to a respective set of 8 compute tiles 200, which form a reduction group. A copy of the 8K input vector is also sent to each reduction group, such that each compute tile 200 receives 1K input activations. Each reduction group generates a single product activation each cycle: at each basic unit 205, the MAC unit 225 computes 64 products, at each compute tile 200, the ALU 215 computes a partial sum of 64*16=1K elements, and at each LLI gather group 270, the gather network 312 provides 2 sets of 8 partial sums (one set per reduction group) to IMLP tile 250, which sums each set of partial sums to generate a pair of output activations (i.e., a 1×2 subvector). The example LLI chip includes 256 reduction groups and generates 256 1×2 subvectors per cycle. Each respective IMLP tile 250 multicasts, via distribution network 316, a corresponding subvector that includes a pair of output activations to every eighth compute tile 200 that requires those output activations as input to a subsequent processing stage. The multicast is performed first horizontally (i.e., via horizontal broadcast paths 316A) and second vertically (i.e., via vertical broadcast paths 316B). Each compute tile 200, receives, via distribution network 316, a respective 1×2 subvector from each of 16 respective IMLP tiles 250 per cycle. To deliver the 16 respective subvectors, each respective 2K×64 crossbar switch selects, for a respective column of compute tiles 200, four respective rows of compute tiles 200 (e.g., via an array of second-level multiplexers) and eight respective horizontal broadcast paths 316A per row (e.g., via an array of first-level multiplexers). Each respective set of vertical broadcast paths 316B of a respective column of compute tiles 200 thereby delivers the same 32 elements, i.e., activations, per cycle to all 32 compute tiles 200 in the respective column (and eight different columns of compute tiles 200 receive the same elements each cycle). At each compute tile 200, demultiplexers of VRF 320 ensure the proper activations are stored at the proper elements of local vector registers. In at least one embodiment, after the first cycle, a 0^{th} IMLP tile 250 broadcasts activations N=0 and N=1 to every eighth compute tile 200 (where they are written to the 0^{th} and 1^{st} rows of a 1K vector register), a 1^{st} IMLP tile 250 broadcasts activations N=64 and N=65 of every eighth compute tile 200 (where they are written to the 64^{th} and 65^{th} rows of a 1K vector register), and a 127^{th} IMLP tile 250 broadcasts activations N=8128 and N=8129 to every eighth compute tile 200 (where they are written to the 960^{th} and 961^{st} rows of a 1K vector register). After 32 cycles, the 1×8K×8K GEMM operation is finished (the 256 slices are processed in parallel), and the 8K activations of the 8K product vector are distributed, e.g., to respective sets of 8 compute tiles 200, which form a reduction group for a subsequent GEMM operation.

According to an embodiment, a 2×16K×16K GEMM operation is mapped to the example LLI chip, and the basic units 205 of the example LLI chip have a batch factor of 2. The 2×16K×16K GEMM multiplies a 16K×16K weight matrix by a 2×16K input activation matrix to produce a 2×16K product activation matrix. The 16K×16K weight matrix is divided into 128 slices that each contain 128 rows, and each respective slice is distributed to a respective set of 16 compute tiles 200, which form a reduction group. A copy of the 2×16K input activation matrix is also sent to each reduction group, such that each compute tile 200 receives 2×1K input activations. Each reduction group generates two product activations each cycle: at each basic unit 205, two MAC units 225 each compute 64 products, at each compute tile 200, the ALU 215 computes two partial sums of 64*16=1K elements, and at each LLI gather group 270, the gather network 312 provides a first set of 16 partial sums and a second set of 16 partial sums (one set per batch) to IMLP tile 250, which sums each set of partial sums to generate one output activation per batch, i.e., a 2×1 output activation submatrix. The example LLI chip includes 128 reduction groups (i.e., four columns of 32 rows of LLI gather groups 270—for a 16K reduction, each LLI gather group forms a single reduction group) and generates 128 2×1 output activation submatrices per cycle. Each respective IMLP tile 250 then multicasts, via distribution network 316, a corresponding submatrix that includes a single output activation for each batch to compute tiles 200 that require those output activations as input to a subsequent processing stage. The multicast is performed first horizontally (i.e., via horizontal broadcast paths 316A) and second vertically (i.e., via vertical broadcast paths 316B). Each compute tile 200, receives, via distribution network 316, a respective 2×1 submatrix from each of 8 respective IMLP tiles 250 per cycle. To deliver the 8 respective submatrices, each respective 2K×64 crossbar switch 316C selects, for a respective column of compute tiles 200, two respective rows of compute tiles 200 (e.g., via an array of second-level multiplexers) and four respective horizontal broadcast paths 316A per row (e.g., via an array of first-level multiplexers). Each respective set of vertical broadcast paths 316B of a respective column of compute tiles 200 thereby delivers the same 16 elements, i.e., activations, per cycle to all 32 compute tiles 200 in the respective column (and four different columns of compute tiles 200 receive the same elements each cycle). At each compute tile 200, demultiplexers of VRF 320 ensure the proper activations are stored at the proper elements of local vector registers. In an embodiment, after the first cycle, a 0^{th} IMLP tile 250 broadcasts activation N=0 of each batch to every sixteenth compute tile 200 (where they are written to a 0^{th} row of separate 1K vector registers), a 1^{st} IMLP tile 250 broadcasts activation N=128 of each batch to every sixteenth compute tile 200 (where they are written to a 128^{th} row of separate 1K vector registers), and a 127^{th} IMLP tile 250 broadcasts activation N=16256 to every sixteenth compute tile 200 (where they are written to 896^{th} rows of separate 1K vector registers). After 128 cycles, the 2×16K×16K GEMM operation is finished (the 128 slices are processed in parallel), and the 2×16K activations of the 2×16K product matrix are distributed, e.g., to respective sets of 16 compute tiles 200, which form a reduction group for a subsequent GEMM operation.

According to an embodiment, a 2×16K×64K GEMM operation is mapped to the example LLI chip, and the basic units 205 of the example LLI chip have a batch factor of 2. The 2×16K×64K GEMM multiplies a 16K×64K weight matrix by a 2×64K input activation matrix to produce a 2×16K product activation matrix. The 16K×64K weight matrix is divided into 32 slices that each contain 512 rows, and each respective slice is distributed to a respective set of 64 compute tiles 200, which form a reduction group. A copy of the 2×64K input activation matrix is also sent to each reduction group, such that each compute tile receives 2×1K input activations. The example LLI chip includes 32 reduction groups (i.e., four columns of 32 rows of LLI gather groups 270—for a 64K reduction, sets of 4 LLI gather groups 270 form a single reduction group) and generates 32 2×1 output activation submatrices per cycle. Specifically, each reduction group generates two product activations each cycle: at each basic unit 205, two MAC units 225 each compute 64 products, at each compute tile 200, the ALU 215 computes two partial sums of 64*16=1K elements, and at each LLI gather group 270, the gather network 312 provides a first set of 16 partial sums and a second set of 16 partial sums (one set per batch) to IMLP tile 250, which sums each set of partial sums to generate one intermediate result per batch (i.e., a first-level local reduction that sums 16 partial sums), i.e., a 2×1 intermediate result submatrix. The intermediate result submatrices are transmitted between IMLP tiles 250 via reduction network 314, and a final result in the form of a 2×1 activation submatrix (i.e., a single activation per batch) is computed by one of IMLP tiles 250 of the reduction group. In an embodiment, the 4 IMLP tiles 250 of each reduction group are connected by reduction network 314 in a tree structure, such that two IMLP tiles 250 compute second-level local reductions of 32 partial sums (i.e., by summing two first-level local reductions of 16 partial sums) in a first stage and a single IMLP tile 250 computes the final result in a second stage (i.e., by summing the two second-level local reductions of 32 partial sums). In an embodiment, the 4 IMLP tiles 250 of each reduction group are connected by reduction network 314 in series, such that 3 consecutive local reductions (first of 32 partial sums, then of 48 partial sums, and finally of 64 partial sums) provide the final result. A single IMLP tile 250 of each reduction group then multicasts, via distribution network 316, a corresponding submatrix that includes a single output activation for each batch to compute tiles 200 that require those output activations as input to a subsequent processing stage. The multicast is performed first horizontally (i.e., via horizontal broadcast paths 316A) and second vertically (i.e., via vertical broadcast paths 316B). Each compute tile 200, receives, via distribution network 316, a respective 2×1 submatrix from each of 2 respective IMLP tiles 250 per cycle. To deliver the 2 respective submatrices, each respective 2K×64 crossbar switch selects, for a respective column of compute tiles 200, two respective rows of compute tiles 200 (e.g., via an array of second-level multiplexers)—as only one in four IMLP tiles 250 computes submatrices—and two respective horizontal broadcast paths 316A per row (e.g., via an array of first-level multiplexers). Each respective set of vertical broadcast paths 316B of a respective column of compute tiles 200 thereby delivers 4 elements, i.e., activations, per cycle to all 32 compute tiles 200 in the respective column (and four different columns of compute tiles 200 receive the same elements each cycle). At each compute tile 200, demultiplexers of VRF 320 ensure the proper activations are stored at the proper elements of local vector registers. In an embodiment, after the first cycle, a 0^{th} IMLP tile 250 broadcasts activation N=0 of each batch to every sixteenth compute tile 200 (where they are written to a 0^{th} row of separate 1K vector registers), a 1^{st} IMLP tile 250 broadcasts activation N=512 of each batch to every sixteenth compute tile 200 (where they are written to a 512^{th} row of separate 1K vector registers), and a 31^{st} IMLP tile 250 broadcasts activation N=15872 of each batch to every sixteenth compute tile 200 (where they are written to a 512^{th} row of separate 1K vector registers). After 512 cycles, the 2×16K×64K GEMM operation is finished (the 512 slices are processed in parallel), and the 2×16K activations of the 2×16K product matrix are distributed, e.g., to respective sets of 16 compute tiles 200, which form a reduction group for a subsequent GEMM operation.

According to an embodiment, a 2×16K×4K GEMM operation is mapped to the example LLI chip, and the basic units 205 of the example LLI chip have a batch factor of 2. The 2×16K×4K GEMM multiplies a 16K×4K weight matrix by a 2×4K input activation matrix to produce a 2×16K product activation matrix. The 16K×4K weight matrix is divided into 512 slices that each contain 8 rows, and each respective slice is distributed to a respective set of 4 compute tiles 200, which form a reduction group. A copy of the 2×4K input activation matrix is also sent to each reduction group, such that each compute tile 200 receives 2×1K input activations. Each reduction group generates two product activations each cycle: at each basic unit 205, two MAC units 225 each compute 64 products, at each compute tile 200, the ALU 215 computes two partial sums of 64*16=1K elements, and at each LLI gather group 270, the gather network 312 provides 4 sets of 4 partial sums per batch to IMLP tile 250, which sums each set of partial sums to generate four output activations per batch, i.e., a 2×4 output activation submatrix. The example LLI chip includes 512 reduction groups (i.e., 4 reduction groups per LLI gather group 270) and generates 512 2×4 output activation submatrices per cycle. Each activation submatrix is stored at the IMLP tile 250 that produced it (e.g., in vector RF 262) until the 2×16K×4K GEMM operation is finished after 8 cycles, at which point each respective IMLP tile 250 stores a respective 2×32 output activation submatrix in its respective vector RF 262. Prior to a subsequent processing stage, a reduction operation is carried out via reduction network 314. In at least one embodiment, the 128 IMLP tiles 250 are organized as nodes of a tree, each respective IMLP tile 250 computes (e.g., via vector datapath 265) a 2×1 local sum matrix for its respective 2×32 output activation submatrix, each parent node IMLP tile 250 computes (e.g., via vector datapath 265) a 2×1 intermediate sum matrix, and the tree's root node IMLP tile 250 computes (e.g., via vector datapath 265) a 2×1 global sum matrix. The 2×1 global sum matrix is distributed to each respective IMLP tile 250 via reduction return network 314B, and each respective IMLP tile 250 normalizes (e.g., via vector datapath 265) the values of its respective 2×32 output activation submatrix based on the 2×1 global sum matrix to produce a 2×32 normalized activation submatrix. Each respective IMLP tile 250 then multicasts, via distribution network 316, its respective 2×32 normalized activation submatrix to destination compute tiles 200 that require the normalized activations contained therein as input to the subsequent processing stage. The multicast is performed first horizontally (i.e., via horizontal broadcast paths 316A) and second vertically (i.e., via vertical broadcast paths 316B). Each compute tile 200, receives, via distribution network 316, a respective 2×32 normalized activation submatrix from each of 32 respective IMLP tiles 250, and the number of distribution cycles required to distribute the normalized activation submatrices depends on a bandwidth of the distribution network 316. For the example LLI chip—in which distribution network 316 includes a total of 2K horizontal broadcast paths and 64 vertical broadcast paths per column of compute tiles 200, the normalized activation submatrices are distributed over 32 distribution cycles, 64 elements per cycle. To deliver the 64 elements per cycle, each respective 2K×64 crossbar switch selects, for a respective column of compute tiles 200, eight rows of compute tiles 200 (e.g., via an array of second-level multiplexers) and eight respective horizontal broadcast paths per row (e.g., via an array of first-level multiplexers). Each respective set of vertical broadcast paths 316B of a respective column of compute tiles 200 thereby delivers the same 64 elements, i.e., activations, per cycle to all 32 compute tiles 200 in the respective column (and four different columns of compute tiles 200 receive the same elements each cycle). At each compute tile 200, demultiplexers of VRF 320 ensure the proper activations are stored at the proper elements of local vector registers. In an embodiment, after the first cycle, a 0^{th} IMLP tile 250 broadcasts activation N=0 of each batch to every sixteenth compute tile 200 (where they are written to a 0^{th} row of separate 1K vector registers), a 1^{st} IMLP tile 250 broadcasts activation N=32 of each batch to every sixteenth compute tile 200 (where they are written to a 32^{nd} row of separate 1K vector registers), and a 127^{th} IMLP tile 250 broadcasts activation N=16352 to every sixteenth compute tile 200 (where they are written to 992^{nd} rows of separate 1K vector registers). After 32 distribution cycles, the 2×16K product matrix is distributed to respective sets of 16 compute tiles 200, which form a reduction group for a subsequent GEMM operation.

In one or more embodiments, a bandwidth required of distribution network 316 to distribute, in a single distribution cycle, all activations generated in a single compute cycle is dependent on the K dimension of the current GEMM operation, which determines the ratio of compute intensity to output bandwidth. For example, for a current GEMM operation that performs a K=2K reduction, each pair of compute tiles 200 of the example LLI chip described above will produce one activation every cycle (per basic unit batch factor) such that distribution network 316 requires sufficient bandwidth to transmit 1K activations per cycle, while for a current GEMM operation that performs a K=128K reduction, each group of 128 compute tiles will collaborate to produce a single activation every cycle (per batch factor) such that distribution network 316 only requires sufficient bandwidth to transmit 16 activations per cycle (per basic unit batch factor). In one or more embodiments, if the K dimension of the current GEMM operation is sufficiently small that the distribution network 316 is unable to distribute, in a single distribution cycle, all activations generated in a single compute cycle, then undistributed activations can be stored at IMLP tiles 250 (e.g., in vector RF 262) until distribution network 316 is able to distribute them.

In one or more embodiments, a multicast factor (i.e., number of destinations) of distribution network 316 is dependent on the N dimension of the current GEMM operation, which will become the K dimension of a subsequent GEMM operation. For example, for a current GEMM operation with an N=16K activation dimension, distribution network 316 must provide each output activation to 128 compute tiles 200 (as there will be 128 total reduction groups each consisting of 16 compute tiles for the subsequent GEMM operation), while for a current GEMM operation with an N=64K activation dimension, distribution network 316 must provide each output activation to 32 compute tiles 200 (as there will be 32 total reduction groups each consisting of 64 compute tiles for the subsequent GEMM operation).

In one or more embodiments, LLI gather groups 270 and configurable network 310 are architected for typical GEMM reduction dimensions to ensure efficient utilization of datapaths. However, for reduction dimensions smaller than the typical reduction dimensions, outputs can remain local. For example, for operations with smaller reduction dimensions (e.g., for a reduction dimension of less than 1K for the example LLI chip described above), an individual compute tile 200 and/or a group of basic units 205 thereof can form an entire reduction group, enabling efficient reductions to be performed, e.g., at ALU 215, without incurring excessive data movement or network overhead. This flexible grouping approach allows an LLI system to dynamically adapt to the requirements of various neural network layers, supporting a wide range of tensor operations while balancing wire count and chip area.

### LLI Device and Systems

FIG. 4A illustrates an LLI device 400, according to at least one embodiment. The LLI device 400 may be used to implement one or more layers of an LLM. The LLI device 400 comprises an array of LLI gather groups 270 that are each coupled to a router 405. In an embodiment, a processor such as the LLI device 400 may be configured to implement a neural network model, such as an LLM. The neural network model may be implemented as software instructions executed by the processor or, in other embodiments, the processor can include a matrix of hardware elements configured to process a set of inputs (e.g., electrical signals representing values) to generate a set of outputs, which can represent activations of the neural network model. In yet other embodiments, the neural network model can be implemented as a combination of software instructions and processing performed by a matrix of hardware elements. Implementing the neural network model can include determining a set of parameters for the neural network model through, e.g., supervised or unsupervised training of the neural network model as well as, or in the alternative, performing inference using the set of parameters to process novel sets of inputs.

In an embodiment, the LLI device 400 is fabricated as an integrated circuit device. The LLI device 400 is a latency hiding architecture designed to perform one or more operations of an LLM. While one exemplary device is provided herein for illustrative purposes, it should be strongly noted that such processor is set forth for illustrative purposes only, and that any processor may be employed to supplement and/or substitute for the same. In an embodiment, LLI device 400 is the example LLI chip that includes four columns of 32 rows of LLI gather groups 270, each LLI gather group 270 includes 16 compute tiles 200 per IMLP tile 250 (i.e., the LLI system includes 2K compute tiles or 128 gather groups 270), each compute tile 200 includes 16 basic units 205, and each basic unit is 64 elements wide (i.e., each compute tile 200 is 1K elements wide). In various embodiments, the LLI device 400 includes various numbers of rows and columns of LLI gather groups 270, and each LLI gather group includes various numbers of compute tiles per IMLP tile. The number of rows and columns of LLI gather groups 270 can be determined, e.g., based on a total number of compute tiles that fit in a die area or a desired aspect ratio.

The LLI gather groups 270 are interconnected through a configurable network, e.g., configurable network 310. Arrangement of the LLI gather groups 270 facilitates efficient communication and data processing for LLM operations. The configurable network connects tiles within and across LLI gather groups 270 and enables deterministic, low-latency communication, ensuring that results are transmitted directly to registers in appropriate destination tiles for subsequent processing. Each LLI gather group 270 performs GEMM operations, reductions, and intermediate layer processing tasks, and the configurable network supports efficient and direct data transfers between the LLI gather groups 270.

Furthermore, the dynamic network (i.e., provided by routers 260 of IMLP tiles 250 of gather groups 270) facilitates data-dependent communication between the LLI gather groups 270 and with external devices. In an embodiment, the dynamic network complements the configurable network by facilitating inter-chip,-board, and -rack routing.

The combination of the configurable network and the dynamic network provides for both deterministic and flexible data movement, thereby supporting the scalability and adaptability of the LLI device 400—and of a system of one or more LLI devices 400—for various neural network configurations. For example, this communication structure enables the LLI device 400—or a system of multiple LLI devices 400—to efficiently process large-scale LLM workloads with low latency and high throughput. The configurable network is configured to handle the majority of intra-chip communication, while the dynamic network enables connectivity for inter-chip communication and external device access.

One or more LLI devices 400 may be configured to accelerate thousands of High Performance Computing (HPC), data center, cloud computing, and machine learning applications. The LLI device 400 may be configured to accelerate numerous deep learning systems and applications for autonomous vehicles, simulation, computational graphics such as ray or path tracing, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like. LLI devices 400 provide several key advantages over conventional computing systems:
Reduced Latency: By performing reductions locally within compute tiles and IMLP tiles and transmitting results directly through a configurable network, LLI devices 400 eliminate the need for intermediate storage in centralized memory (such as SRAM or DRAM). This direct, deterministic data movement minimizes communication delays and enables faster layer-to-layer processing—critical for real-time inference.
Lower Data Movement Overhead: By pre-configuring compute tiles, basic units, and a configurable network for a specific neural network workload, LLI devices 400 route results directly to the next required processing stage. This reduces unnecessary across-chip data transfers, decreases congestion, and improves overall system throughput.
Optimized Memory Bandwidth Utilization: By aggregating and reducing partial results as close as possible to where they are generated, LLI devices 400 reduce the volume of data that must traverse on-chip networks. This optimizes the use of available memory bandwidth and enables support for larger models and longer context lengths.
Improved Energy Efficiency: By providing for localized reduction (i.e., at compute tiles and/or gather groups) and by providing direct data transfers (i.e., via a configurable network), reliance on high-bandwidth, power-hungry global memory accesses is greatly reduced. By minimizing off-chip and long-distance on-chip data movement, LLI devices 400 can achieve significant energy savings—which is especially important for large-scale deployments.
Scalability and Flexibility for Different Neural Network Configurations: The distributed reduction approach and configurable network provided by LLI devices 400 allows for efficient scaling across multiple tiles, chips, boards, and racks. As neural network size or context length increases, a system of one or more LLI devices 400 can adapt by allocating additional compute and IMLP tiles—and do so without introducing bottlenecks associated with centralized reduction or memory architectures. A system of one or more LLI devices 400 thereby provides a flexible foundation for supporting evolving model requirements. Overall, these advantages enable LLI devices 400 to deliver high-performance, low-latency, and energy-efficient neural network inference at scale.

An LLM can be mapped to one or more LLI devices 400 by partitioning the computational workload across the array of LLI gather groups 270 within each LLI device 400. Each LLI gather group 270 comprises compute tiles 200 and IMLP tiles 250, which are configured to execute specific portions of the LLM's processing layers. The mapping process involves assigning segments of the LLM's GEMM operations, reductions, and intermediate layer processing tasks to the appropriate compute tiles 200 and IMLP tiles 250 within the LLI gather groups 270 and to specific memory rows within those tiles. For each LLM processing layer, the required calculations for GEMM operations are distributed among the compute tiles 200, which operate in parallel to generate partial results. These partial results are then transmitted via the configurable network to the IMLP tiles 250 for reduction operations and further processing, such as normalization or activation functions. The configurable network is pre-configured based on the LLM architecture and ensures deterministic, low-latency communication between tiles, allowing results to be routed directly to a next stage of computation without reliance on centralized memory in an embodiment.

In one or more embodiments, when an LLM exceeds the capacity of a single LLI device 400, the LLM is further partitioned across multiple LLI devices 400. The routers 405 within each device facilitate inter-device communication by connecting the configurable networks of different LLI devices 400 through a dynamic distribution network. This dynamic distribution network supports data-dependent communication and inter-chip routing, enabling the system to scale efficiently for large LLMs by distributing processing across multiple chips, boards, and racks.

The mapping strategy is adaptable to various LLM configurations, context lengths, and reduction dimensions. It allows for flexible allocation of compute and IMLP tile resources, ensuring that each portion of the LLM is processed efficiently and that data movement is minimized. This hierarchical and distributed mapping approach enables the LLI system to support real-time, low-latency LLM inference at scale.

FIG. 4B illustrates a block diagram of example LLM to LLI mapping 410, according to at least one embodiment. The RMSNorm units 135 and 165, rope units 145, softmax 152, EAdd 162 and 175, registers 142 and 172, and swiGLU 168 operations are performed by IMLP tile(s) 250. More specifically, non-GEMM computations and operations starting from partial results of a previous GEMM to prepare an input to a subsequent GEMM operation are performed by IMLP tile(s) 250. The remaining operations, along with data format conversions, are performed by compute tiles 200. In an embodiment, outputs computed by RMSNorm units 135 and 165, BMM2 155, and swiGLU 168 are converted from FP32 format to NVFP4 format. In an embodiment, outputs computed by the rope units 145, V vectors in the memory 140, and softmax 152 are converted from FP32 format to FP8 format.

Execution of RMSNorm 135 is distributed across LLI gather groups 270 to enhance performance and reduce latency. Each compute tile 200 begins by calculating a sum of squared input values for a subset of an input vector, leveraging the local SRAM and arithmetic units to perform the required multiply-accumulate (FMA) operations. Partial results from multiple compute tiles 200 are then transmitted to the IMLP tiles 250 via the configurable network (e.g., via gather network 312) for further reduction. Among IMLP tiles 250, a hierarchical reduction is performed to compute a global sum of squared values across the compute tiles 200. The global sum is used to calculate the mean squared value and its inverse square root using dedicated vector datapaths 265 and MUFU (multi-function unit) operations in the IMLP tiles 250. The resulting normalization factor is broadcast back to compute tiles 200 (e.g., via reduction return network 314B), where the factor is applied to the input vector through element-wise multiplication to produce the normalized output. This distributed approach promotes efficient utilization of local resources, reduces data movement, and supports high-throughput processing for large vector lengths, such as those encountered in LLM inference workloads.

Execution of the rope units 145 by IMLP tiles 250 involves applying rotational position encodings to input vectors, a necessary step in transformer-based LLMs to incorporate positional information into the data. Each IMLP tile 250 processes a subset of an input vector, performing element-wise operations to apply the rotational embeddings. Specifically, the embeddings, often precomputed and stored in the SRAM 255, are retrieved and combined, by vector datapath 265, with the input vector through a series of MAC operations. For example, in a Llama-70B model, the IMLP tiles 250 execute two floating-point MAC operations per element to apply the rotation embeddings. The results are stored in the vector RF 262 within the IMLP tiles 250 and subsequently transmitted by the configurable network (e.g., via reduction collect network 314A) to the next processing stage. The localized computation minimizes data movement, leverages the high-speed SRAM 255 within the IMLP tiles 250, and supports low-latency execution of the rope operation, which is important for maintaining the throughput of the LLM inference pipeline.

Flash attention operations performed by the compute tiles 200 involve a sequence of matrix-vector and vector-based computations optimized for low-latency execution. Initially, compute tiles 200 execute the first batch matrix multiplication (BMM1 150), where a query vector is multiplied by a matrix representing associative relationships to generate attention scores. In an embodiment, one or more of the query, key, and value vectors are cached in the local RAMs 220. Compute tiles 200 handle these steps in parallel, leveraging vector registers 230 to store intermediate results and facilitate efficient data movement. The scores are then processed through the softmax 152, which includes calculating the maximum value across the scores, normalizing the scores by subtracting the maximum, and applying an exponential function to compute the attention weights.

Execution of the softmax 152 by the IMLP tiles 250 is optimized for low-latency and high-throughput processing of LLM workloads. Each IMLP tile 250 is configured to perform the necessary computations for softmax, including calculating the maximum value across a vector, normalizing the input values by subtracting the maximum, applying the exponential function, and performing a summation to compute the normalization factor. For example, in a Llama-70B model with a context length of 4K, the softmax operation begins with each IMLP tile 250 computing a 64-wide maximum reduction locally for a gather group 270, followed by a hierarchical reduction across all IMLP tiles 250 to determine the global maximum. The global maximum is then broadcast back to the IMLP tiles 250 (e.g., via reduction return network 314B), where each IMLP tile 250 computes the exponential of the normalized values and performs a local summation. A final reduction across the IMLP tiles 250 aggregates the local sums to compute the global normalization factor, which is subsequently inverted and distributed (e.g., via reduction return network 314B) to all of the IMLP tiles 250. The normalized values are then multiplied by the resulting factor to produce the final softmax output. This distributed approach leverages the parallelism of the IMLP tiles 250 and the configurable network to minimize data movement and ensure efficient execution, making the architecture well-suited for real-time LLM inference.

Following the softmax 152, the second batch matrix multiplication (BMM2 155) is performed by the compute tiles 200, where the attention weights are multiplied by the value matrix to produce the attended output. The compute tiles 200 are configured to execute these operations with high throughput by spatially distributing the computations across multiple compute tiles 200 and performing reductions locally to minimize data movement. This architecture ensures that flash attention operations are executed with minimal latency, supporting real-time processing requirements for LLMs.

The EAdd 162 and 175 by the IMLP tiles 250 performs element-wise accumulation over time. For example, in the context of Llama-70B, the Eadd operation combines outputs from two sources, such as the output of the proj 160 and the input data stored in the register 142, with each vector having a length of 8K. The proj 160 output is generated across compute tiles 200 and distributed to IMLP tiles 250 in cycles. As the proj 160 output arrives, the IMLP tiles 250 perform the addition operation in parallel, with each IMLP tile 250 processing a subset of the vector. The output of FC1 166 arrives over multiple cycles at IMLP tiles 250 and the swiGLU 168 activation function is executed as the inputs arrive by combining a Swish operation, implemented using a multi-function unit (MUFU) for non-linear transformations, with a gated linear unit (GLU) operation. The output of swiGLU 168 is then distributed to the compute tiles 200 (e.g., via distribution network 316) for processing by FC2 170.

For Llama-405B with a context length of 128K, EAdd 175 combines a 1×16K output of FC2 170 with the registers 172 stored across IMLP tiles 250. Each IMLP tile 250 is equipped with dedicated arithmetic units, such as FADD units, to execute the addition in a single cycle per subset. This parallelized approach ensures that the Eadd operation is completed with minimal latency, aligning with the high-throughput requirements of LLM inference. The results are then stored locally or transmitted to subsequent processing stages through the configurable network for further computations.

FIG. 4C illustrates a flowchart of a method 420 for performing tensor operations for LLM operations using groups of compute tiles (i.e., reduction groups), according to at least one embodiment. Each block of method 420, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 420 is described, by way of example, with respect to the basic unit 205, compute tile 200, IMLP tile 250, LLI gather group 270, and LLI device 400 of FIGS. 2A, 2B, 2C, 2D, 2E, and 4A, respectively. However, this method may additionally or alternatively be executed by any one system, or any combination of systems, including, but not limited to, those described herein. Furthermore, persons of ordinary skill in the art will understand that any system that performs method 420 is within the scope and spirit of embodiments of the present disclosure.

At step 425, a number of inputs is distributed to the set of gather groups (e.g., LLI gather groups 270) to compute partial results, each gather group comprising a plurality of compute tiles for performing operations. In an embodiment, each compute tile comprises shared control logic that configures the set of gather groups to process inputs in parallel, reduction and computation logic (ALU), and an array of basic units. In an embodiment, each basic unit comprises RAM and arithmetic logic directly coupled to the RAM.

In an embodiment, the operations comprise tensor operations. In an embodiment, a number of gather groups in the set corresponds to a tensor shape of the tensor operation. In an embodiment, the tensor operations include at least one of matrix-vector calculations or matrix-matrix calculations. In an embodiment, a number of gather groups in the set corresponds to a reduction dimension. In an embodiment, a number of gather groups in the set corresponds to a context length. In an embodiment, a number of gather groups in the set is based on an attention algorithm. In an embodiment, the RAM of each basic unit stores weights and a vector register of each basic unit stores an activation vector. In an embodiment, the RAM stores key and value vectors for attention.

At step 430, one or more basic units are configured to compute, in parallel, per-basic unit results. In an embodiment, the per-basic unit results are partial dot products computed by multiplying a partial vector by a partial weight matrix, the partial vector being a portion of an input vector and the partial weight matrix being a portion of a weight matrix corresponding to an LLM.

At step 435, the per-basic unit results at each compute tile are combined by the reduction computation logic thereof to produce a per-group result.

At step 440, the per-group results are transmitted, by a configurable network coupled to each compute tile, to an IMLP tile to perform a next processing operation when the per-group result completes a tensor operation or to combine the per-group result with one or more other per-group results to complete the operation. In an embodiment, the operation comprises a tensor operation and a result of the tensor operation is an activation. In an embodiment, temporal iterations are performed to compute a result of the tensor operation. In an embodiment, a vector register receives a vector directly from the configurable network.

The next processing operation involves summing, by the IMLP tile, a plurality of partial results to generate one or more elements of or corresponding to an output vector or matrix, e.g., one or more activations, or generating a per-IMLP tile result (which is subsequently summed, along with additional per-IMLP tile results by a further IMLP tile, to produce one or more elements of or corresponding to an output vector or matrix).

The compute tile 200 design comprises an array of basic units, each with local RAM 220, vector registers 230, and MAC unit 225, designed, e.g., for GEMM operations in LLM inference. The IMLP tile 250 design features a vector datapath 265, local SRAM 255 for performing vector operations and reductions, such as mean and max, during LLM inference operations. The LLI gather group 270 includes multiple compute tiles 200 coupled to an IMLP tile 250 for performing GEMM operations across the compute tiles 200, where partial results are combined by the IMLP tile 250 and transmitted through the configurable network for subsequent processing.

FIG. 4D illustrates a flowchart of a method 445 for performing calculations for LLM operations using an IMLP tile, according to at least one embodiment. Each block of method 445, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 445 is described, by way of example, with respect to the IMLP tile 250, LLI gather group 270, and LLI device 400 of FIGS. 2D, 2E, and 4A, respectively. However, this method may additionally or alternatively be executed by any one system, or any combination of systems, including, but not limited to, those described herein. Furthermore, persons of ordinary skill in the art will understand that any system that performs method 445 is within the scope and spirit of embodiments of the present disclosure.

At step 450, computed values are received from a configurable network.

In an embodiment, the computed values are partial results that are processed by a vector datapath (e.g., vector datapath 265) to produce computed values. In an embodiment, the computed values are one or more elements of an output vector or matrix, e.g., one or more activations.

At step 455, the computed values are stored in a register file within a first IMLP tile. In an embodiment, the first IMLP tile receives the computed values directly from one or more compute tiles. In an embodiment, the first IMLP tile receives the computed values comprising the partial results from a gather network that couples a set of compute tiles to the register file.

In at least one embodiment, the computed values are stored in a register file (e.g., vector RF 262) after each of one or more compute cycles performed by a set of compute tiles connected to the first IMLP tile by the configurable network.

At step 460, the computed values are processed by a vector datapath to produce local reduction results. In an embodiment, the processing of the computed values by the vector datapath comprises performing reduction calculations, the reduction calculations including at least one of mean, maximum, standard deviation, variance, product of multiple elements, index of a maximum (argmax), index of a minimum (argmin), or sum reduction.

At step 465, the local reduction results are directly transmitted to at least one of a compute tile or a second IMLP tile through the configurable network. In an embodiment, the first IMLP tile and a set of compute tiles that compute partial results for a tensor operation comprise a gather group within a reduction group that includes at least one of the first IMLP tile and the second IMLP tile. In an embodiment, the local reduction results comprise per-group results that are directly transmitted to at least the second IMLP tile over a reduction network that is coupled to the register file within the first IMLP tile. In an embodiment, the first IMLP tile receives the per-group results from at least the second IMLP tiles and the per-group results are combined within the first IMLP tile to compute an output for the tensor operation. In an embodiment, the per-group results comprise an output for the tensor operation and the second IMLP tile is included in a next processing stage. In an embodiment, a tensor shape for the tensor operation defines a reduction dimension over which a plurality of the partial results and per-group results are reduced to produce an output for the tensor operation.

In an embodiment, a distribution network coupled to a register file in the second IMLP transmits the output directly to a set of compute tiles. In an embodiment, the first IMLP tile directly transmits the output through the reduction network to a third IMLP tile in a next processing stage. In an embodiment, a distribution network coupled to a register file in the third IMLP transmits the output directly to a set of compute tiles.

In an embodiment, the local reduction results are directly transmitted through a reduction collect network. In an embodiment, the operation comprises an LLI operation. In an embodiment, a number of gather groups in the reduction group corresponds to a context length of the LLI operation. In an embodiment, the results produced by the vector datapath are activations of the LLI operation.

In an embodiment, a global reduction result is received, e.g., via the second IMLP tile or a further IMLP tile, through the configurable network. In an embodiment, the computed values stored in the register file are modified based on the global result to provide reduced results. In at least one embodiment, the computed values are elements of dot-product attention scores, and the reduced results are elements of normalized attention scores. In at least one embodiment, the computed values are elements of a projection of an attention block output, and the reduced results are activations of an activation layer output.

The LLM system 100 provides low-latency inferencing for LLMs and comprises a combination of GPU-based prefill boards and LLI-based boards, where the LLI boards include one or more LLI devices 400 that are optimized for GEMM and reduction operations. The configurable network enables direct data transmission of results from one operation to inputs of the next operation, avoiding storage in a centralized SRAM or DRAM, thereby reducing latency and power consumption. The dynamic distribution network is implemented, e.g., as a mesh on-chip, a flattened butterfly or all-to-all connection between chips, enabling data-dependent communication and inter-chip routing for large-scale LLM inference. Multiple LLI devices 400 may be incorporated into a scalable system architecture organized in a 2D mesh, with inter-chip communication facilitated by the static and dynamic distribution networks, supporting medium to large LLMs with low latency and high efficiency. The LLM operations are mapped to compute tiles 200 and IMLP tiles 250 within the LLI devices 400 that are configurable and adaptable to different LLMs and workloads.

The LLI device 400 may be configured to perform spatially distributed GEMM and reduction operations across compute and IMLP tiles, minimizing data replication and optimizing memory usage during LLM inference. LLM operations are mapped to the compute and IMLP tiles, considering spatial and temporal factors, to optimize resource utilization and adapt to varying context lengths and reduction dimensions. The compute and IMLP tiles are programmable to handle intermediate layer processing tasks such as layer normalization, softmax, and other neural network operations, providing capability for handling evolving algorithms. Reduction operations (e.g., sum, max, mean) are enabled by the configurable network, where results are directly transmitted to subsequent processing stages without intermediate storage.

FIG. 4E illustrates a flowchart of a method 470 for performing LLM operations, according to at least one embodiment. Each block of method 470, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 470 is described, by way of example, with respect to the LLI gather group 270 and LLI device 400 of FIGS. 2E and 4A, respectively. However, this method may additionally or alternatively be executed by any one system, or any combination of systems, including, but not limited to, those described herein. Furthermore, persons of ordinary skill in the art will understand that any system that performs method 470 is within the scope and spirit of embodiments of the present disclosure.

At step 475, input data are distributed across a number of compute tiles organized into groups of compute tiles to compute tensor operations for a first layer of a neural network model using the input data, where the number is based on a tensor shape of each tensor operation.

In an embodiment, a first spatial distribution of computations, corresponding to a tensor operation for a first layer of a neural network, is determined, and inputs to the tensor operation are distributed across a number of compute tiles organized into reduction groups, where the number of compute tiles per reduction group is based on a tensor shape of the tensor operation.

At step 480, partial results computed by each group of compute tiles are combined to produce per-group results, where each group of compute tiles is associated with an IMLP tile. In an embodiment, partial results computed by eight compute tiles on either side of the IMLP tile are combined by the IMLP tile to produce a per-group result. In an embodiment, the per-group result for each group of compute tiles is computed by the IMLP tile associated with the group of compute tiles. In an embodiment, one or more compute tiles within the group of compute tiles comprises an array of basic units that compute a multi-element partial result included in the partial results. In an embodiment, a quantity of groups of compute tiles is selected based on a context length of the neural network model. In an embodiment, attention key vectors and value vectors are stored within each compute tile.

In an embodiment, partial results are computed by the compute tiles of each reduction group and summed, by an IMLP tile, to provide one or more elements of or corresponding to an output vector or matrix, e.g., one or more activations (e.g., via method 420). In an embodiment, two sets of partial results, each computed by eight compute tiles on either side of the IMLP tile, are summed by the IMLP tile to produce two elements of or corresponding to an output vector or matrix.

At step 485, the per-group results are distributed through a configurable network directly to registers in one or more IMLP tiles or to additional compute tiles to perform one or more additional calculations for the first layer or a second layer of the neural network model. In an embodiment, the LLI operations include at least one of scaling, normalization, or activation functions. In an embodiment, the configurable network comprises a gather network configured to transmit the partial results from the compute tiles in the group of compute tiles to the IMLP tile associated with the group of compute tiles, a reduction network configured to aggregate the per-group results from the one or more IMLP tiles to produce at least one reduction result, and a distribution network configured to broadcast the at least one reduction result directly to the registers. In an embodiment, at least one of the gather network, the reduction network, or the distribution network is configured is based on the tensor shape. In an embodiment, the configurable network is dynamically configured to modify a connection to one or more of the registers. In an embodiment, the neural network model is mapped to one or more of the groups of compute tiles. In an embodiment, the mapping spatially and temporally maps operations for the neural network model across the groups of compute tiles.

In embodiment, the tensor operations include a matrix vector calculation and the tensor shape defines a reduction dimension over which a plurality of the partial results and per-group results are reduced to produce an output for the matrix vector calculation. In an embodiment, the tensor operations include a matrix matrix calculation of dimensions M×N×K for M×K activations, N×K weights, an M×N output of the tensor operations, and K is a reduction dimension for at least one reduction operation. In an embodiment, the method is implemented across at least one of: multiple LLI devices that each comprise a plurality of groups of compute tiles; multiple modules that each comprise a plurality of LLI devices; or multiple racks that each comprise a plurality of modules.

In an embodiment, the one or more additional calculations comprise a reduction operation (e.g., a normalization, softmax, or activation) that is performed (e.g., via method 445) to provide reduced results corresponding to the tensor operation at IMLP tiles of the reduction groups. In an embodiment, a spatial distribution of computations, corresponding to a second tensor operation for the neural network, is determined, and a mapping of the IMLP tiles of the reduction groups to the compute tiles is determined based on both the spatial distribution of the computations corresponding to the first tensor operation and the spatial distribution of the computations corresponding to the second tensor operation. In addition, the configurable network is configured, based on the determined mapping, to multicast, from the IMLP tiles of the reduction groups determined for the first tensor operation to the compute tiles, the reduced results provided at step 485. In an embodiment, the reduced results provided at step 485—which serve as inputs to the second tensor operation, are distributed, from the IMLP tiles of the reduction groups determined for the first tensor operation to the compute tiles, via the configurable network.

FIG. 4F illustrates a timeline for performing a sequence of LLM operations using an LLI system, according to at least one embodiment. The sequence of LLM operations includes BMM1 150, Softmax 152, and BMM2 155. A first portion of the computations corresponding to BMM1 150 are performed by compute tiles of an LLI system over 128 compute cycles. Immediately after the first portion of the computations corresponding to BMM1 150 are completed, a second portion of the computations corresponding to BMM1 150 are performed by the compute tiles of the LLI system over 128 additional compute cycles. The 128 additional compute cycles overlap with both (i) the 128 cycles during which computations of local statistics and exponent corresponding to a first portion of Softmax 152 are performed by ALU 215, and (ii) 33 compute cycles during which computations of global statistics 156 corresponding to a first portion of Softmax 152 are performed by IMLP tiles.

Immediately after the second portion of the computations corresponding to BMM1 150 and the first portion of computations corresponding to Softmax 152 are completed by the compute tiles, computations of global statistics 156 corresponding to the second portion of Softmax 152 are performed by IMLP tiles and the compute tiles begin 128 compute cycles over which a first portion of the computations corresponding to BMM2 155 are performed. While the compute tiles begin performing computations corresponding to the first portion of BMM2 155, computations corresponding to the second portion of Softmax 152 are performed by ALU 215 and IMLP tiles. Upon completion of the computations corresponding to the first portion of BMM2 155, a second portion of the computations corresponding to BMM2 155 are performed by the compute tiles of the LLI system over 128 additional compute cycles. The 128 additional compute cycles overlap with 14 compute cycles during which post BMM2 IMLP operations 157 corresponding to the first portion of BMM2 155 are performed by IMLP tiles. Following completion of the second portion of the computations corresponding to BMM2 155, 14 compute cycles are required for computations corresponding to post BMM2 IMLP operations 157 corresponding to the second portion of BMM2 155. As illustrated by FIG. 4F, due to pipelining, all latency associated with Softmax 152 is hidden, and half of the latency (i.e., 14 of 28 cycles) associated with post BMM2 IMLP operations is hidden. Persons of ordinary skill in the art will understand that, in various embodiments, different combinations of LLM operations (e.g., Proj 160, EAdd 162, RMSNorm 165, FC1 166, SwiGLU 168, and FC2 170)—as well as operations associated with different types of neural networks—can be performed and pipelined in a similar manner to that illustrated in FIG. 4F.

[Note to Inventors—The following (until the section Exemplary Computing System) is standard material that is included in NVIDIA patent applications. It is not necessary to do a thorough review of this material, but the claims at the end should be reviewed.]

In some examples, the model(s) (e.g., machine learning models, deep neural networks, language models, LLMs, VLMs, multi-modal language models, perception models, tracking models, fusion models, transformer models, diffusion models, encoder-only models, decoder-only models, encoder-decoder models, neural radiance field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Additionally, in some embodiments, the systems and methods described herein may be utilized within a simulation environment (e.g., NVIDIA's DriveSIM, ISAAC GYM, and/or ISAAC SIM) using simulated data (e.g., simulated sensor data of simulated sensors of a virtual or simulated machine). For example, simulated sensor data and/or map data (simulated or real) may be used to perform various operations within the simulation environment, such as to generate the simulation data and/or operate a machine. These simulated operations may be used to test performance of the underlying algorithms, systems, image processing pipelines, and/or processes prior to deploying them in the real-world. In some instances, the simulation may be used to generate synthetic training data—e.g., training data including landmarks, features, objects, etc.—so that the synthetic training data (in addition to or alternatively from real-world data) may then be processed to perform one or more of the operations described herein.

In any example, such as where a simulation environment is used for testing, validation, training, etc., the simulation environment and/or associated training data may be rendered or otherwise generated using one or more light transport algorithms—such as ray-tracing and/or path-tracing algorithms. In some embodiments, the simulation environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system for using or developing universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

Approaches in accordance with various embodiments can be used to generate one or more parameters for a content generation environment. In at least one embodiment, a trained machine learning (ML) and/or artificial intelligence (AI) system, such as a large language model (LLM) or a vision language model (VLM), may be used to generate parameters for the content generation environment, such as, but not limited to, camera settings, scene lighting, video parameters, and/or the like, used for displaying objects within a scene. The parameters may be based on an input provided by a user or a proxy for a user to a trained language model (e.g., LLM, VLM, etc.) that can then generate one or more settings in accordance with the input. Various embodiments may be used to generate settings in two-dimensional (2D) or three-dimensional (3D) settings. For embodiments that incorporate one or more language models—that is, one or more LLMs, one or more VLMs, or a combination of LLMs and VLMs, the language model(s) may receive an input (e.g., a prompt, a request, a query, etc.) that is parsed or otherwise formatted to generate a deterministic output. For example, the input provided to the language model may include a particular format for the output results, an example of desired output results, a particular list of parameters and their respective formatting, and the like. An input generator (e.g., a prompt generator), which may be driven or otherwise guided by one or more AI and/or ML systems, may be used to generate this input based on an initial input received from a user, a device, a proxy, and/or the like. A modified input generated by the input generator may then be provided to the language model, which will generate an output set of parameters. This output may be further evaluated with a reviewer, or other system, to ensure that the output is appropriate. Thereafter, a configuration file may be generated and/or the parameters may be directly provided to an environment to configure different components (e.g., camera settings, lighting, etc.) based on the parameters generated by the language model.

### LLI Computing System

A computing system can be implemented using one or more LLI modules, such as printed circuit boards, where each LLI module includes an array of LLI devices 400, with each LLI device 400 containing multiple LLI gather groups 270. The LLI gather groups 270 comprise the compute tiles 200 and the IMLP tiles 250, which are responsible for performing matrix-vector operations, reductions, and intermediate layer processing tasks, e.g., as required for neural network inference operations. The compute tiles 200 execute matrix-vector multiplications and generate partial results, while the IMLP tiles 250 perform reduction operations and other vector-based computations. The LLI modules are interconnected via high-speed communication links, such as NVLink or other on-board interconnects, enabling efficient data transfer and coordination between LLI modules. The configurable network within each LLI device 400 provides deterministic, low-latency communication within reduction groups, while routers 405 facilitate communication between LLI devices 400 on the same LLI module and with external devices and/or modules. In an embodiment, one or more LLI modules are designed to accelerate LLM inference by providing highly parallel and scalable computational resources.

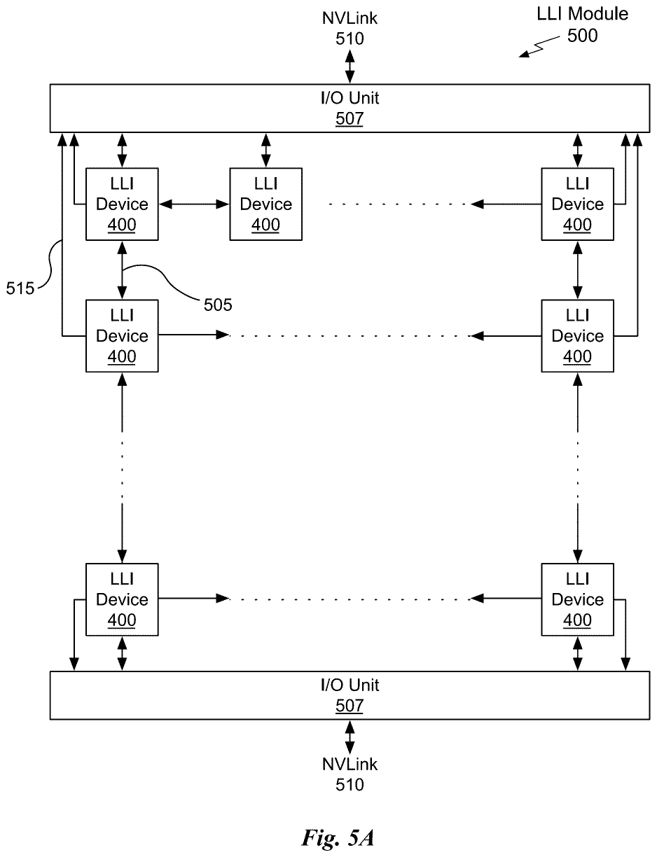

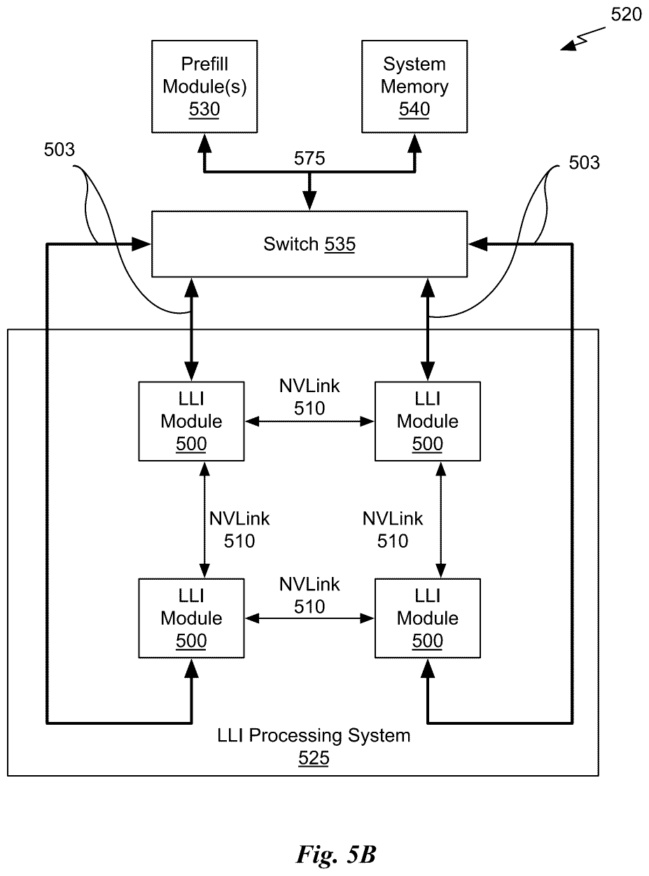

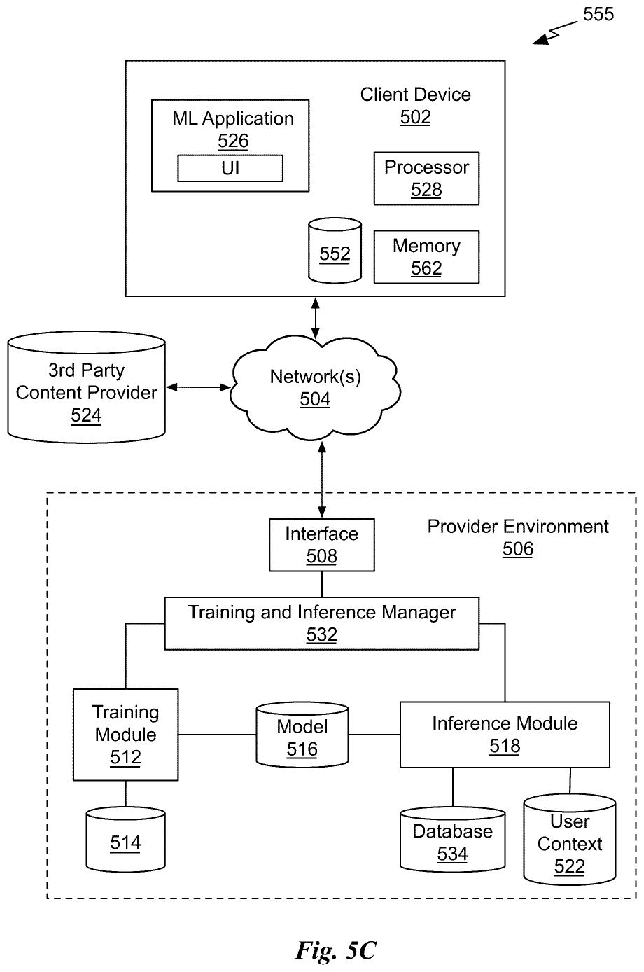

FIG. 5A is a conceptual diagram of an LLI module 500 implemented using the LLI devices 400 of FIG. 4A, in accordance with an embodiment. The LLI module 500 may be connected to a processor (not shown), peripheral devices, other LLI modules 500 or other modules via one or more high-speed NVLink 510 interconnects through an input/output (I/O) units 507. The LLI module 500 may also be connected to a system memory comprising a number of memory devices through the I/O units 507. In an embodiment, the system memory may comprise a number of dynamic random access memory (DRAM) devices. The DRAM devices may be configured as a high-bandwidth memory (HBM) subsystem, with multiple DRAM dies stacked within each device.

In an embodiment, the LLI module 500 comprises a printed circuit board (PCB) containing 24 LLI devices 400 in a 6×4 array. Connectors along two edges of the board bring out 100 Gb/s differential signals for a 2D mesh network coupled to the I/O units 507. In an embodiment, connections 505 and 515 comprise ground-referenced signals (GRS). In an embodiment, connections 505 and 515 comprise dynamic distribution network interconnections. The NVLink 510 interconnect enables systems to scale and include one or more LLI modules 500. Results generated by the LLI module 500 may be routed to a different LLI module 500 via NVLink 510. Data and/or commands may be transmitted by the NVLink 510 to/from the LLI module 500. The I/O units 507 are configured to transmit and receive communications (e.g., commands, data, etc.) over the interconnects 505 and 515. In an embodiment, the I/O units 507 may implement a well-known type of interface for communicating with external devices. In an embodiment, a host processor executes a driver kernel that implements an application programming interface (API) that enables one or more applications executing on the host processor to schedule operations for execution on the LLI module 500.

The LLI device 400 or LLI module 500 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the LLI device 400 is embodied on a single semiconductor substrate. In another embodiment, the LLI device 400 is included in a system-on-a-chip (SoC) along with one or more other devices such as additional LLI devices 400, memory, a reduced instruction set computer (RISC) CPU, a memory management unit (MMU), a digital-to-analog converter (DAC), and the like. In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user.

Multiple LLI modules 500 can be connected together, either within a single rack or across multiple racks, to scale the system's processing capacity for very large neural networks (e.g., LLMs). The LLI modules 500 may be organized in a 2D mesh or grid topology, with inter-board communication supported by high-bandwidth links and dynamic network routing. In an embodiment, this arrangement allows an LLM workload to be partitioned and distributed across a large number of LLI devices 400, enabling parallel processing of different layers or segments of the LLM.

A processing system can include one or more LLI devices 400 and/or one or more LLI modules 500 in combination with one or more GPU modules. In an embodiment, such a processing system utilizes the one or more GPU modules (e.g., GPU-based prefill boards) to perform processing required for the prefill phase of LLM inference, while the LLI modules 500 perform processing required for the decode phase. The integration of multiple LLI modules 500, each with multiple LLI devices 400, with multiple GPU modules provides a scalable, energy-efficient, and low-latency solution for deploying large-scale LLMs in data centers or edge environments. This system architecture supports real-time inference, efficient memory bandwidth utilization, and flexible adaptation to various LLM configurations and workloads.

FIG. 5B is a conceptual diagram of a processing system 520 implemented using the LLI module 500 of FIG. 5A, in accordance with an embodiment. The processing system 520 may be configured to implement the methods 420, 445, and 470 shown in FIGS. 4C, 4D, and 4E, respectively. The processing system 520 includes an LLI processing system 525 (which includes a plurality of LLI modules 500), switch 535, system memory 540, and one or more GPU modules 530. In an embodiment, the GPU modules 530 perform prefill operations for LLM inference and the LLI modules 500 perform decode operations. In an embodiment, each LLI module 500 includes a 4×6 array of inference (LLI) devices 400. Each LLI device 400 includes two different types of tiles, specifically, compute tiles 200 and IMLP tiles 250, as well as shared control, a configurable network, and a dynamic distribution network. Multiple modules may be connected (via an interconnect 503) to scale up the system processing capacity. Adjacent cabinets enclosing the boards may be cabled together for massive capacity. The LLI processing system 525 may be implemented as a circuit board substrate and each of the LLI modules 500 and/or system memory 540 may be packaged devices. In an embodiment, the GPU module(s) 530, switch 535, and the LLI processing system 525 are situated on a single semiconductor platform.

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth. Processing system 520 combines the LLI modules 500 and GPU module(s) 530 to more effectively distribute computational tasks and streamline data transfers, thereby meeting the rising performance expectations, e.g., for next-generation model deployments.

Processing system 520 may include, and/or be configured to perform functions of, one or more processing cores and/or components thereof, such as Tensor Cores (TCs), Tensor Processing Units (TPUs), Pixel Visual Cores (PVCs), Ray Tracing (RT) Cores, Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 510 provides high-speed communication links between each of the LLM modules 500 within the LLI processing system 525 and, when interconnect 503 comprises NVLink, between the LLI processing system 525 and the GPU module(s) 530 and system memory 540. As shown, a communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the GPU module(s) 530 may be directly connected to the system memory 540. Further, the GPU module(s) 530 may be directly connected to the LLI processing system 525. Where there is direct, or point-to-point connection between components, the communication bus 575 may include a PCIe link to carry out the connection. In these examples, a PCI bus need not be included in the processing system 520.

Although a particular number of NVLink 510 and interconnect 503 connections are illustrated in FIG. 5B, the number of connections to each of the LLM modules 500 and the switch 535 may vary. The switch 535 interfaces between the interconnect 503 and the LLM modules 500 and between the GPU module(s) 530 and system memory 540 and the LLM modules 500. In an embodiment, the switch 535 supports two or more protocols to interface between various different connections and/or links. In another embodiment (not shown), the interconnect 503 provides one or more communication links between each of the LLI modules 500 directly. One or more of the NVLink 510 high-speed communication links may be implemented as a physical NVLink interconnect or either an on-chip or on-die interconnect using the same protocol as the NVLink 510.

In an embodiment, the signaling rate of each NVLink 510 is 20 to 25 Gigabits/second and each LLI module 500 includes two NVLink 510 interfaces (as shown in FIG. 5A). Each NVLink 510 provides a data transfer rate of 25 Gigabytes/second in each direction, with six links providing 400 Gigabytes/second. In an embodiment, the NVLink 510 allows direct load/store/atomic access from the LLI devices 400 to system memory 540. In an embodiment, LLILLISRAM 255 and RAM 220 is software visible memory. In an embodiment, the NVLink 510 includes support for Address Translation Services (ATS), allowing the LLI devices 400 to directly access page tables within the switch 535. One or more of the NVLinks 510 may also be configured to operate in a low-power mode.

In an embodiment, the system memory 540, SRAM 255, and/or RAM 220 support Single-Error Correcting Double-Error Detecting (SECDED) Error Correction Code (ECC) to protect data. ECC provides higher reliability for compute applications that are sensitive to data corruption. Reliability is especially important in large-scale cluster computing environments where LLI devices 400 process very large datasets and/or run applications for extended periods.

In an embodiment, the memory interface supports a unified memory to provide a single unified virtual address space for LLI device 400 memory, enabling data sharing between virtual memory systems. In an embodiment the frequency of accesses by an LLI device 400 to system memory 540 is traced to ensure that memory pages are moved to the physical memory of the LLI device 400 that is accessing the pages more frequently. In an embodiment, the NVLink 510 supports address translation services allowing the LLI device 400 to directly access page tables in the switch 535 and providing full access to the system memory 540 by the LLI device 400.

Control instructions (software) and data are stored in the system memory 540 which may take the form of a variety of computer-readable media. The computer-readable media may be any available media that may be accessed by the processing system 520. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the system memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by processing system 520. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the processing system 520 to perform various functions. The GPU module(s) 530 and/or LLI module(s) 500 may be configured to execute at least some of the computer-readable instructions to control one or more components of the processing system 520 to perform one or more of the methods and/or processes described herein. The GPU(s)within the GPU module(s) 530 may each include one or more cores (e.g., one, two, four, eight, twenty-eight, seventy-two, etc.) that are capable of handling a multitude of software threads simultaneously. The GPU(s) may include any type of processor and may include different types of processors depending on the type of processing system 520 implemented (e.g., processors with fewer cores for mobile devices and processors with more cores for servers). For example, depending on the type of processing system 520, the processor may be an Advanced RISC Machines (ARM) processor implemented using Reduced Instruction Set Computing (RISC) or an x86 processor implemented using Complex Instruction Set Computing (CISC). The processing system 520 may include one or more CPUs and/or GPUs in addition to one or more microprocessors or supplementary co-processors, such as math co-processors.

The GPU module(s) 530 and/or the LLI processing system 525 may be configured to execute at least some of the computer-readable instructions to control one or more components of the processing system 520 to perform one or more of the methods and/or processes described herein. The GPU module(s) 530 may be used by the processing system 520 to render graphics (e.g., 3D graphics) or perform general purpose computations. For example, the GPU module(s) 530 may be used for General-Purpose computing on GPUs (GPGPU). In embodiments, the GPU module(s) 530 and/or the LLI processing system 525 may discretely or jointly perform any combination of the methods, processes and/or portions thereof.

Although the various blocks of FIG. 5B are shown as connected via the communication bus 575 with lines, this is not intended to be limiting and is for clarity only. For example, in some embodiments, a presentation component, one or more additional components such as display device(s), processor(s), input device(s), and network(s) may be connected to the communication bus 575. The display device(s) may include a display (e.g., a monitor, a touch screen, a television screen, a heads-up-display (HUD), other display types, or a combination thereof), speakers, and/or other presentation components. The display device(s) may receive data and output the data (e.g., as an image, video, sound, etc.).

A network interface (not shown) may enable the processing system 520 to be logically coupled to other devices including the input devices, the display device(s), and/or other components, some of which may be built in to (e.g., integrated in) the processing system 520. Illustrative input device(s) include a microphone, mouse, keyboard, joystick, game pad, game controller, satellite dish, scanner, printer, wireless device, etc. The input device(s) may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the processing system 520. The processing system 520 may be coupled to depth cameras, such as stereoscopic camera systems, infrared camera systems, RGB camera systems, touchscreen technology, and combinations of these, for gesture detection and recognition. Additionally, the processing system 520 may be coupled to accelerometers or gyroscopes (e.g., as part of an inertia measurement unit (IMU)) that enable detection of motion. In some examples, the output of the accelerometers or gyroscopes may be used by the processing system 520 to render immersive augmented reality or virtual reality.

Further, the processing system 520 may be coupled to a network (e.g., a telecommunications network, local area network (LAN), wireless network, wide area network (WAN) such as the Internet, peer-to-peer network, cable network, or the like) through a network interface (not shown) for communication purposes. The processing system 520 may be included within a distributed network and/or cloud computing environment. The network interface may include one or more receivers, transmitters, and/or transceivers that enable the processing system 520 to communicate with other computing devices via an electronic communication network, included wired and/or wireless communications. The network interface may be implemented as a network interface controller (NIC) that includes one or more data processing units (DPUs) to perform operations such as (for example and without limitation) packet parsing and accelerating network processing and communication. The network interface may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The processing system 520 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The processing system 520 may also include a hard-wired power supply, a battery power supply, or a combination thereof (not shown). The power supply may provide power to the processing system 520 to enable the components of the processing system 520 to operate.

Each of the foregoing modules and/or devices may even be situated on a single semiconductor platform to form the processing system 520. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments but should be defined only in accordance with the following claims and their equivalents. In other words, the processing system 520 of FIG. 5B is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the processing system 520 of FIG. 5B.

### Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the LLI module 500 of FIG. 5A and/or exemplary processing system 520 of FIG. 5B—e.g., each device may include similar components, features, and/or functionality of the LLI module 500 and/or processing system 520.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example LLI module 500 of FIG. 5A and/or processing system 520 of FIG. 5B. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the LLI device 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the LLI device 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5C illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN), convolutional neural network (CNN), generative pre-trained transformer (GPT), other transformer-based model, etc. Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment, a processor 528 (or a processor of training module 512 or inference module 518) will be a central processing unit (CPU). As mentioned, however, resources in such environments can utilize GPUs and/or LLI devices (such as LLI device 400 or LLI module 500) to process data for at least certain types of requests. With thousands of cores, GPUs are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506.

In at least one embodiment, supervised and/or unsupervised training can be performed by the client device 502 and/or the provider environment 506. In at least one embodiment, a set of training data 514 (e.g., classified or labeled data) is provided as input to function as training data. In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the GPU module 530 comprises one or more graphics processing units (GPUs). A GPU is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The GPU can be configured to process the graphics primitives to generate a frame buffer (e.g., pixel data for each of the pixels of the display).

An application writes model data for a scene (e.g., a collection of vertices and attributes) to a memory such as a system memory 540. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the GPU including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 540. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 540. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The graphics processing pipeline may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the GPU. The API provides an abstraction for a programmer that lets a programmer utilize specialized graphics hardware, such as the GPU, to generate the graphical data without requiring the programmer to utilize the specific instruction set for the GPU. The application may include an API call that is routed to the device driver for the GPU. The device driver interprets the API call and performs various operations to respond to the API call. In some instances, the device driver may perform operations by executing instructions on the CPU. In other instances, the device driver may perform operations, at least in part, by launching operations on the GPU utilizing an input/output interface between the CPU and the GPU. In an embodiment, the device driver is configured to implement the graphics processing pipeline utilizing the hardware of the GPU.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA GeForce Now (GFN), Google Stadia, and the like.

### Streaming System

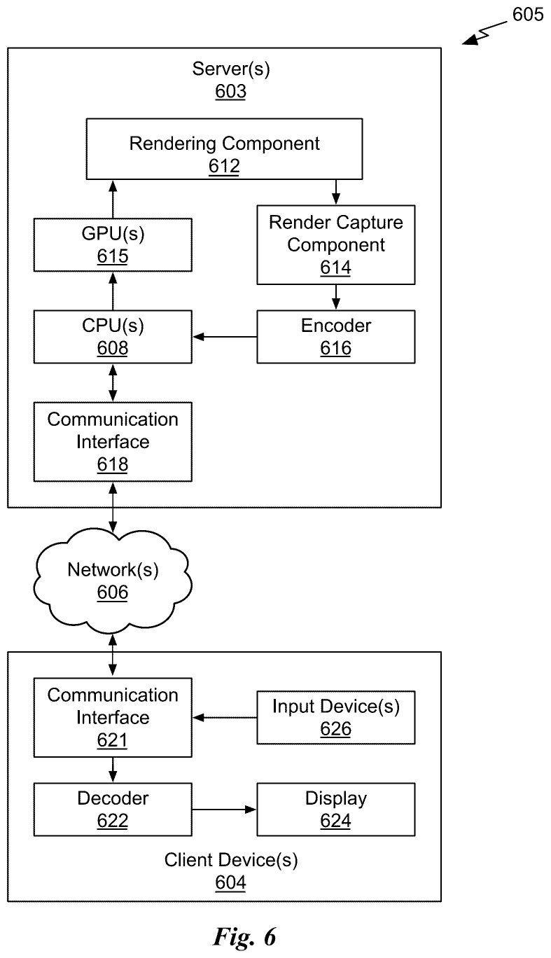

FIG. 6 is an example system diagram for a streaming system 605, in accordance with some embodiments of the present disclosure. FIG. 6 includes server(s) 603 (which may include similar components, features, and/or functionality to the example LLI module 500 of FIG. 5A and/or exemplary processing system 520 of FIG. 5B), client device(s) 604 (which may include similar components, features, and/or functionality to the example LLI module 500 of FIG. 5A and/or exemplary processing system 520 of FIG. 5B), and network(s) 606 (which may be similar to the network(s) described herein).

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units—such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

In at least one embodiment, one or more techniques described herein utilize a oneAPI programming model. In at least one embodiment, a oneAPI programming model refers to a programming model for interacting with various compute accelerator architectures. In at least one embodiment, oneAPI refers to an application programming interface (API) designed to interact with various compute accelerator architectures. In at least one embodiment, a oneAPI programming model utilizes a DPC++ programming language. In at least one embodiment, a DPC++ programming language refers to a high-level language for data parallel programming productivity. In at least one embodiment, a DPC++ programming language is based at least in part on C and/or C++ programming languages. In at least one embodiment, a oneAPI programming model is a programming model such as those developed by Intel Corporation of Santa Clara, CA.

In at least one embodiment, oneAPI and/or oneAPI programming model is utilized to interact with various accelerator, GPU, processor, and/or variations thereof, architectures. In at least one embodiment, oneAPI includes a set of libraries that implement various functionalities. In at least one embodiment, oneAPI includes at least a oneAPI DPC++ library, a oneAPI math kernel library, a oneAPI data analytics library, a oneAPI deep neural network library, a oneAPI collective communications library, a oneAPI threading building blocks library, a oneAPI video processing library, and/or variations thereof.

In at least one embodiment, a oneAPI DPC++ library, also referred to as oneDPL, is a library that implements algorithms and functions to accelerate DPC++ kernel programming. In at least one embodiment, oneDPL implements one or more standard template library (STL) functions. In at least one embodiment, oneDPL implements one or more parallel STL functions. In at least one embodiment, oneDPL provides a set of library classes and functions such as parallel algorithms, iterators, function object classes, range-based API, and/or variations thereof. In at least one embodiment, oneDPL implements one or more classes and/or functions of a C++ standard library. In at least one embodiment, oneDPL implements one or more random number generator functions.

In at least one embodiment, a oneAPI math kernel library, also referred to as oneMKL, is a library that implements various optimized and parallelized routines for various mathematical functions and/or operations. In at least one embodiment, oneMKL implements one or more basic linear algebra subprograms (BLAS) and/or linear algebra package (LAPACK) dense linear algebra routines. In at least one embodiment, oneMKL implements one or more sparse BLAS linear algebra routines. In at least one embodiment, oneMKL implements one or more random number generators (RNGs). In at least one embodiment, oneMKL implements one or more vector mathematics (VM) routines for mathematical operations on vectors. In at least one embodiment, oneMKL implements one or more Fast Fourier Transform (FFT) functions.

In at least one embodiment, a oneAPI data analytics library, also referred to as oneDAL, is a library that implements various data analysis applications and distributed computations. In at least one embodiment, oneDAL implements various algorithms for preprocessing, transformation, analysis, modeling, validation, and decision making for data analytics, in batch, online, and distributed processing modes of computation. In at least one embodiment, oneDAL implements various C++ and/or Java APIs and various connectors to one or more data sources. In at least one embodiment, oneDAL implements DPC++ API extensions to a traditional C++ interface and enables GPU usage for various algorithms.

In at least one embodiment, a oneAPI deep neural network library, also referred to as oneDNN, is a library that implements various deep learning functions. In at least one embodiment, oneDNN implements various neural network, machine learning, and deep learning functions, algorithms, and/or variations thereof.

In at least one embodiment, a oneAPI collective communications library, also referred to as oneCCL, is a library that implements various applications for deep learning and machine learning workloads. In at least one embodiment, oneCCL is built upon lower-level communication middleware, such as message passing interface (MPI) and libfabrics. In at least one embodiment, oneCCL enables a set of deep learning specific optimizations, such as prioritization, persistent operations, out of order executions, and/or variations thereof. In at least one embodiment, oneCCL implements various CPU and GPU functions.

In at least one embodiment, a oneAPI threading building blocks library, also referred to as oneTBB, is a library that implements various parallelized processes for various applications. In at least one embodiment, oneTBB is utilized for task-based, shared parallel programming on a host. In at least one embodiment, oneTBB implements generic parallel algorithms. In at least one embodiment, oneTBB implements concurrent containers. In at least one embodiment, oneTBB implements a scalable memory allocator. In at least one embodiment, oneTBB implements a work-stealing task scheduler. In at least one embodiment, oneTBB implements low-level synchronization primitives. In at least one embodiment, oneTBB is compiler-independent and usable on various processors, such as GPUs, PPUs, CPUs, and/or variations thereof.

In at least one embodiment, a oneAPI video processing library, also referred to as oneVPL, is a library that is utilized for accelerating video processing in one or more applications. In at least one embodiment, oneVPL implements various video decoding, encoding, and processing functions. In at least one embodiment, oneVPL implements various functions for media pipelines on CPUs, GPUs, and other accelerators. In at least one embodiment, oneVPL implements device discovery and selection in media centric and video analytics workloads. In at least one embodiment, oneVPL implements API primitives for zero-copy buffer sharing.

In at least one embodiment, a oneAPI programming model utilizes a DPC++ programming language. In at least one embodiment, a DPC++ programming language is a programming language that includes, without limitation, functionally similar versions of CUDA mechanisms to define device code and distinguish between device code and host code. In at least one embodiment, a DPC++ programming language may include a subset of functionality of a CUDA programming language. In at least one embodiment, one or more CUDA programming model operations are performed using a oneAPI programming model using a DPC++ programming language.

In at least one embodiment, any application programming interface (API) described herein is compiled into one or more instructions, operations, or any other signal by a compiler, interpreter, or other software tool. In at least one embodiment, compilation comprises generating one or more machine-executable instructions, operations, or other signals from source code. In at least one embodiment, an API compiled into one or more instructions, operations, or other signals, when performed, causes one or more processors such as graphics processors, or any other logic circuit further described herein to perform one or more computing operations.

It should be noted that, while example embodiments described herein may relate to a CUDA programming model, techniques described herein can be utilized with any suitable programming model, such HIP, oneAPI, and/or variations thereof.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

In at least one embodiment, one or more components of systems and/or processors disclosed above can communicate with one or more CPUs, ASICs, GPUs, FPGAs, or other hardware, circuitry, or integrated circuit components that include, e.g., an upscaler or upsampler to upscale an image, an image blender or image blender component to blend, mix, or add images together, a sampler to sample an image (e.g., as part of a DSP), a neural network circuit that is configured to perform an upscaler to upscale an image (e.g., from a low resolution image to a high resolution image), or other hardware to modify or generate an image, frame, or video to adjust its resolution, size, or pixels; one or more components of systems and/or processors disclosed above can use components described in this disclosure to perform methods, operations, or instructions that generate or modify an image.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method for performing low latency inference (LLI) operations, comprising:
distributing input data across a number of compute tiles organized into groups of compute tiles to compute tensor operations for at least a processing operation of a neural network model using the input data, wherein the number is based on a tensor shape of at least one tensor operation;
combining partial results computed by at least one group of compute tiles to produce one or more per-group results, wherein at least one group of compute tiles is associated with an inter-matrix layer processing (IMLP) tile; and
distributing the per-group results through a configurable network directly to registers in one or more IMLP tiles or to additional compute tiles to perform additional calculations for a next processing operation of the neural network model.

2. The method of claim 1, wherein the one or more per-group result for the at least one group of compute tiles is computed by the IMLP tile associated with the group of compute tiles.

3. The method of claim 1, wherein one or more compute tiles within the at least one group of compute tiles comprises an array of basic units that compute a multi-element partial result included in the partial results.

4. The method of claim 1, wherein a quantity of groups of compute tiles is selected based on a context length of the neural network model.

5. The method of claim 1, further comprising storing attention key vectors and value vectors within at least one compute tile.

6. The method of claim 1, further comprising performing additional calculations, including at least one of scaling, normalization, or activation functions, as part of the LLI operations.

7. The method of claim 1, wherein the method is implemented across at least one of:
multiple LLI devices that each comprise a plurality of groups of compute tiles;
multiple modules that each comprise a plurality of LLI devices; or
multiple racks that each comprise a plurality of modules.

8. The method of claim 1, wherein the tensor operations include a matrix vector calculation and the tensor shape defines a reduction dimension over which a plurality of the partial results and per-group results are reduced to produce an output for the matrix vector calculation.

9. The method of claim 1, wherein the tensor operations include a matrix matrix calculation of dimensions M×N×K for M×K activations, N×K weights, an M×N output of the tensor operations, and K is a reduction dimension for at least one reduction operation.

10. The method of claim 1, wherein the configurable network comprises
a gather network configured to transmit the partial results from the compute tiles in the at least one group of compute tiles to the IMLP tile associated with the group of compute tiles,
a reduction network configured to aggregate the per-group results from the one or more IMLP tiles to produce at least one reduction result, and
a distribution network configured to broadcast the at least one reduction result directly to the registers.

11. The method of claim 10, further comprising configuring at least one of the gather network, the reduction network, or the distribution network is based on the tensor shape.

12. The method of claim 11, wherein the configurable network is dynamically configured to modify a connection to one or more of the registers.

13. The method of claim 1, further comprising mapping the neural network model to one or more of the groups of compute tiles.

14. The method of claim 13, wherein the mapping spatially and temporally maps operations for the neural network model across the groups of compute tiles.

15. A system, comprising:
a memory that stores input data; and
a number of compute tiles organized into groups of compute tiles to compute tensor operations for at least a processing operation of a neural network model using the input data, wherein the number is based on a tensor shape of at least one tensor operation and the compute tiles are configured to perform low latency inference(LLI) operations by:
combining partial results computed by at least one group of compute tiles to produce one or more per-group results, wherein at least one group of compute tiles is associated with an inter-matrix layer processing (IMLP) tile; and
distributing the per-group results through a configurable network directly to registers in one or more IMLP tiles or to additional compute tiles to perform additional calculations for a next processing operation of the neural network model.

16. The system of claim 15, wherein a quantity of groups of compute tiles is selected based on a context length of the neural network model.

17. The system of claim 15, wherein the tensor operations include a matrix vector calculation and the tensor shape defines a reduction dimension over which a plurality of the partial results and per-group results are reduced to produce an output for the matrix vector calculation.

18. The system of claim 15, wherein the tensor operations include a matrix vector calculation and the tensor shape defines a reduction dimension over which a plurality of the partial results and per-group results are reduced to produce an output for the matrix vector calculation.

19. The system of claim 15, wherein the tensor operations include a matrix matrix calculation of dimensions M×N×K for M×K activations, N×K weights, an M×N output of the tensor operations, and K is a reduction dimension for at least one reduction operation.

20. The system of claim 15, wherein system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets;
a system implemented at least partially using cloud computing resources;
a system using or deploying one or more inference microservices; or
a system that incorporates one or more machine learning models deployed in a service or microservice along with an OS-level virtualization package (e.g., a container).

21. A non-transitory computer-readable media storing computer instructions for performing low latency inference (LLI) operations that, when executed by one or more processors, cause the one or more processors to perform the steps of:
distributing input data across a number of compute tiles organized into groups of compute tiles to compute tensor operations for at least a processing operation of a neural network model using the input data, wherein the number is based on a tensor shape of at least one tensor operation;
combining partial results computed by at least one group of compute tiles to produce one or more per-group results, wherein at least one group of compute tiles is associated with an inter-matrix layer processing (IMLP) tile; and
distributing the per-group results through a configurable network directly to registers in one or more IMLP tiles or to additional compute tiles to perform additional calculations for next processing operation of the neural network model.

22. The non-transitory computer-readable media of claim 21, further comprising configuring at least one of the gather network, the reduction network, or the distribution network is based on the tensor shape.
